(19) United States
(12) Patent Application Publication
(10) Pub. No.: US 2026/0094023 A1
(43) Pub. Date: Apr. 2, 2026

(54) MANAGING UNTRAINING OF INFERENCE MODELS BASED ON UNDESIRABLE TRAINING DATA

(71) Applicant: Dell Products L.P., Round Rock, TX (US)

(72) Inventors: OFIR EZRIELEV, Be'er Sheva (IL); JEHUDA SHEMER, Kfar Saba (IL); ONUR CELEBIOGLU, Austin, TX (US)

(21) Appl. No.: 18/899,128

(22) Filed: Sep. 27, 2024

(51) Int. Cl. G06N 5/04

(52) U.S. Cl. CPC G06N 5/04

(57) ABSTRACT

Methods and systems for providing computer-implemented services using inference models are disclosed. To provide the computer-implemented services, an inference model may be untrained with respect to undesirable training data to obtain an updated inference model. If any other portions of the training data have embeddings similar to embeddings of the undesirable training data, a first testing process may be performed to determine whether the updated inference model provides consistent and accurate responses based on the other portions of the training data with the similar embeddings. If the inference model does not provide the consistent and accurate responses, the inference model may be re-trained to increase a likelihood that a re-trained updated inference model provides the consistent and accurate responses. If the re-trained updated inference model provides the consistent and accurate responses, the re-trained updated inference model may be a compliant inference model.

### FIELD

Embodiments disclosed herein relate generally to managing inference models. More particularly, embodiments disclosed herein relate to systems and methods to manage untraining of inference models based on embeddings of training data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2H show diagrams illustrating data flows in accordance with an embodiment.

FIG. 2I shows a diagram illustrating a neural network inference model in accordance with an embodiment.

FIGS. 3A-3C show flow diagrams illustrating a method for providing computer-implemented services using inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using inference models. An inference model may be a generative artificial intelligence (AI) model (e.g., a large language model (LLM)) and may generate responses when provided with prompts. The responses may be used, at least in part, to provide the computer-implemented services. However, a quality of the computer-implemented services may be impacted by the knowledge base of the inference model.

Over time, the inference model may be updated through training using training data. However, if undesirable training data (e.g., poisoned training data, proprietary training data) is introduced to the inference model, the inference model may become untrustworthy (e.g., the inference model may be tainted by the poisoned training data) and/or inference generation may increase a likelihood of unauthorized use of the proprietary training data. Responses generated using the inference model may therefore also be untrustworthy, inaccurate, and/or otherwise undesirable (e.g., the inference model may generate responses using an information content of the poisoned training data).

To reduce the inference model's ability to generate inferences based on the undesirable training data, an untraining process may be performed for the inference model. The untraining process may include multiple cycles of untraining using any method followed by optimization and evaluation (e.g., testing) processes until it is determined (e.g., by a subject matter expert (SME)) that information content of the undesirable training data has been sufficiently removed from the knowledge base and, therefore, the inference model is deemed production ready.

However, the untraining process may unintentionally reduce the inference model's ability to generate inferences based on other training data that is desired to be retained with the knowledge base of the inference model. This may occur due to, for example, some amount of good training data being erroneously included as undesirable training data. Therefore, a first portion of the undesirable training data (e.g., the erroneously included data) may have embeddings that are similar to embeddings of the other training data. Due to the erroneous inclusion of good training data in the undesirable training data, the untraining process may unintentionally target relationships included in the other training data while reducing the ability of the inference model to generate inferences based on relationships included in the undesirable training data.

If it is determined that any of the other training data has embeddings similar (e.g., based on a similarity measure threshold) to embeddings of the undesirable training data, a compliance process may be performed to determine whether a partially untrained inference model is a compliant inference model (e.g., an inference model that has been untrained on the undesirable training data while retaining the information content of the other training data to a degree considered sufficient).

During the compliance process, a set of prompts may be obtained that are intended to elicit responses that have a same information content as the other training data that have the similar embeddings (e.g., to the erroneously included data). A first testing process may be performed, using the set of prompts, to determine whether the partially untrained inference model provides consistent and accurate responses to the set of prompts. If the partially untrained inference model is determined to provide the consistent and accurate responses to the set of prompts, the partially untrained inference model may be used as the compliant inference model.

If the partially untrained inference model (e.g., an updated inference model) does not provide the consistent and accurate responses (e.g., a knowledge base of the partially untrained inference model does not have the information content of the other training data), a re-training process may be performed using the other training data and/or the erroneously included training data to obtain a re-trained updated inference model. The re-training process may be performed to increase a likelihood that the re-trained updated inference model provides the consistent and accurate responses to the set of prompts.

To determine whether the re-trained updated inference model provides the consistent and accurate responses to the set of prompts, a second testing procedure may be performed using the set of prompts. If the re-trained updated inference model provides the consistent and accurate responses, it may be concluded that the re-trained updated inference model is the compliant inference model.

If the re-trained updated inference model does not provide the consistent and accurate responses, additional training and/or untraining process may be performed to increase a likelihood that a further updated inference model provides the consistent and accurate responses.

Thus, embodiments disclosed herein may address, among other technical problems, the technical challenge of evaluating when an inference model has been sufficiently untrained on a portion of training data that includes undesirable training data while being sufficiently trained on other training data. By evaluating similarities between embeddings of the undesirable training data and embeddings of the other training data, a likelihood of identifying portions of the other training data that may have been unintentionally untrained for may be increased. Therefore, resource expenditure may be reduced as re-training processes may be limited to the identified portions of the other training data with the similar embeddings. Consequently, conserved resources may be allocated to other tasks and down time of the inference model may be reduced thereby increasing a likelihood of providing computer-implemented services to downstream consumers as desired.

In an embodiment, a method for providing computer-implemented services using inference models is disclosed. The method may include: identifying a portion of training data that: was used to train an inference model of the inference models, and is undesirable; performing a similarity analysis on the portion of the training data and other portions of the training data to identify whether any of the other portions of the training data are similar to the portion of the training data; in a first instance of the performing where the any of the other portions of the training data are similar to the portion of the training data: performing an untraining of the inference model using the portion of the training data to obtain an updated inference model; and performing a compliance process for the updated inference model using the any of the other portions of the training data to obtain a compliant inference model that reflects relationships defined by the any of the other portions of the training data; in a second instance of the performing where the any of the other portions of the training data do not have similar embeddings to the portion of the training data: performing the untraining of the inference model using the portion of the training data to obtain the compliant inference model.

The method may also include providing computer-implemented services using the compliant inference model.

The portion of the training data may be undesirable due to the portion of the training data including at least one type of training data selected from a list of types of training data consisting of: (i) poisoned training data including malicious relationships established by a malicious entity; and (ii) proprietary training data including confidential relationships ascribed to an owner of the proprietary training data.

Performing the similarity analysis may include: obtaining, using at least the portion of the training data, embeddings for the portion of the training data; obtaining, using the inference model and the other portions of the training data, embeddings for the other portions of the training data; performing, using the embeddings for the portion of the training data and the embeddings for the other portions of the training data, a comparison process to obtain similarity measures between the embeddings for the portion of the training data and the embeddings for the other portions of the training data; making a first determination regarding whether any of the similarity measures exceed a similarity measure threshold; and in an instance of the first determination in which at least one similarity measure of the similarity measures exceeds the similarity measure threshold: concluding that the any of the other portions of the training data are similar to the portion of the training data.

Performing the compliance process may include: obtaining, based on the any of the other portions of the training data that are similar to the portion of the training data, a set of prompts intended to elicit responses that have a same information content as an information content of the any of the other portions of the training data that have the similar embeddings; performing, using the set of prompts, a first testing process to determine whether the updated inference model provides consistent and accurate responses to the set of prompts; and in a first instance of the performing the first testing process in which the updated inference model does not provide the consistent and accurate responses: performing, using the any of the other portions of the training data, a re-training process for the updated inference model to obtain a re-trained updated inference model; performing, using the set of prompts, a second testing process to determine whether the re-trained updated inference model provides the consistent and accurate responses; and in a first instance of the performing the second testing process in which the re-trained updated inference model provides the consistent and accurate responses: concluding that the re-trained updated inference model is the compliant inference model.

The method may also include: in a second instance of the performing the first testing process in which the updated inference model provides the consistent and accurate responses: concluding that the updated inference model is the compliant inference model.

The method may also include: in a second instance of the performing the second testing process in which the re-trained updated inference model does not provide the consistent and accurate responses: performing additional training and/or untraining for the re-trained updated inference model to increase a likelihood that a further updated inference model provides the consistent and accurate responses to the set of prompts.

Performing the first testing process may include: obtaining, using the set of prompts, a first set of responses from the updated inference model, the first set of responses comprising: a first response of the first set of responses to a first prompt of the set of prompts; and a second response of the first set of responses to a second prompt of the set of prompts; performing a first response agreement testing process to obtain a first level of agreement between at least the first response of the first set of responses and the second response of the first set of responses; making a second determination regarding whether the first level of agreement meets agreement criteria; in a first instance of the second determination in which the first level of agreement meets the agreement criteria: concluding that the updated inference model provides consistent responses to the set of prompts; and in a second instance of the second determination in which the first level of agreement does not meet the agreement criteria: concluding that the updated inference model does not provide the consistent and accurate responses to the set of prompts.

Performing the first testing process may also include: in the first instance of the second determination in which the first level of agreement meets the agreement criteria: comparing a first information content of the consistent responses to a second information content of the any of the other portions of the training data to obtain a first level of similarity between the first information content and the second information content; making a third determination regarding whether the first level of similarity meets a level of similarity threshold; in a first instance of the third determination in which the first level of similarity meets the level of similarity threshold: concluding that the updated inference model provides the consistent and accurate responses to the set of prompts; and in a second instance of the third determination in which the first level of similarity does not meet the level of similarity threshold: concluding that the updated inference model does not provide the consistent and accurate responses to the set of prompts.

Performing the second testing process may include: obtaining, using the set of prompts, a second set of responses from the re-trained updated inference model, the second set of responses comprising: a first response of the second set of responses to a first prompt of the set of prompts; and a second response of the second set of responses to a second prompt of the set of prompts; performing a second response agreement testing process to obtain a second level of agreement between at least the first response of the second set of responses and the second response of the second set of responses; making a fourth determination regarding whether the second level of agreement meets agreement criteria; in a first instance of the fourth determination in which the second level of agreement meets the agreement criteria: concluding that the re-trained updated inference model provides consistent responses to the set of prompts; and in a second instance of the fourth determination in which the second level of agreement does not meet the agreement criteria: concluding that the re-trained updated inference model does not provide the consistent and accurate responses to the set of prompts.

Performing the second testing process may also include: in the first instance of the fourth determination in which the second level of agreement meets the agreement criteria: comparing a third information content of the consistent responses provided by the re-trained updated inference model to a second information content of the any of the other portions of the training data to obtain a second level of similarity between the third information content and the second information content; making a fifth determination regarding whether the second level of similarity meets the level of similarity threshold; in a first instance of the fifth determination in which the second level of similarity meets the level of similarity threshold: concluding that the re-trained updated inference model provides the consistent and accurate responses to the set of prompts; and in a second instance of the fifth determination in which the second level of similarity does not meet the level of similarity threshold: concluding that the re-trained updated inference model does not provide the consistent and accurate responses to the set of prompts.

Providing the consistent and accurate responses to the set of prompts may indicate that a knowledge base of the re-trained updated inference model has an information content of the any of the other portions of the training data.

Performing the untraining of the inference model may include: modifying weights of an architecture of the inference model until responses generated by the inference model are not based on an information content of the portion of the training data.

The inference model may be a generative artificial intelligence (AI) model.

The similarity analysis may be an embeddings based similarity analysis or an information content based similarity analysis.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

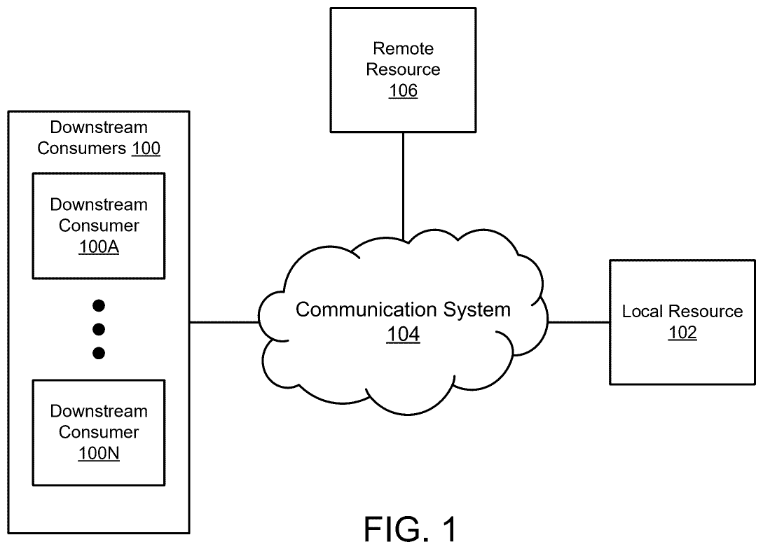

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences (e.g., responses) obtained using the inference models.

To obtain the responses used to provide the computer-implemented services, the inference models may be trained, using training data, to generate the responses when provided with prompts (e.g., ingest data). The inference models may include generative artificial intelligence (AI) inference models (e.g., large language models (LLMs)); therefore, the responses may include new instances of data created by the generative AI inference models based on learned associations from and/or an understanding of the training data. For example, the inference models may be trained using unstructured data, such as stories, essays, audio transcription, video description, and/or other types of human interpretable text, to generate responses of the same.

For example, an inference model may be trained using a set of training data to have a knowledge base. The inference model may obtain prompts based on the set of training data and may generate responses used to provide the computer-implemented services using the knowledge base. However, at least a portion of the training data may be determined to be undesirable training data. The undesirable training data may be based on sensitive (e.g., private, proprietary) information and/or poisoned information (e.g., including relationships generated by a malicious entity). An information content of the undesirable training data may be unsuitable for use in generating the responses due to, for example: (i) a risk of exposure of the sensitive information, (ii) due to data privacy regulations that limit the use of certain information content when providing the computer-implemented services to downstream consumers, (iii) a risk of generating unreliable and/or malicious responses that may further negatively impact other entities upon use of the unreliable and/or malicious responses, and/or (iv) due to other reasons.

To reduce a likelihood of generating inferences (e.g., responses) based on the undesirable training data, the inference model may be untrained with respect to a portion of the training data that has the information content of the undesirable training data.

During untraining, an ability of the inference model to predict relationships included in the undesirable training data may be reduced. However, the inference model may be unintentionally untrained with respect to other information content of other portions of the training data (e.g., training data that is to be retained with the knowledge base of the inference model) during the untraining process. This may occur due to, for example, a portion of the other training data (e.g., not undesirable training data, good training data) being erroneously included as undesirable training data prior to the untraining process. The portion of the training data used to untrain the model may, therefore, include both good and bad training data. Consequently, the inference model may have a reduced ability to predict relationships included in the other training data, which may lead to a reduction in a quality and/or availability of the computer-implemented services to downstream consumers.

In general, embodiments disclosed herein may provide methods, systems, and/or devices for determining whether inference models retain desired information content following untraining. To do so, first embeddings may be obtained for an undesirable portion of training data and second embeddings may be obtained for other portions of the training data. The first embeddings and the second embeddings may be compared to determine whether any of the second embeddings are similar (e.g., based on a similarity measure threshold) to the first embeddings. If any of the second embeddings are deemed similar to the first embeddings, an untraining for the inference model based on the undesirable training data may unintentionally untrain the inference model for a portion of the other training data as well.

Following untraining the inference model using the undesirable training data, a compliance process may be performed to obtain a compliant inference model (e.g., an inference model that is sufficiently untrained on the undesirable training data and sufficiently trained on other training data). During the compliance process, a first testing process may be performed to determine whether an updated (e.g., untrained) inference model provides consistent and accurate responses to a set of prompts intended to elicit responses with an information content of the other training data (e.g., the information content that is desired to be retained). During the first testing process, a second inference model (e.g., a trusted inference model) may compare an information content of responses generated by the updated inference model that are responsive to a set of prompts. If the updated inference model provides the consistent and accurate responses, the updated inference model may be used as the compliant inference model.

If the updated inference model does not provide the consistent and accurate responses, a re-training process may be performed for the updated inference model using the other training data to increase the updated inference model's ability to generate responses based on the information content of the other training data and to obtain a re-trained updated inference model. Following the re-training process, a second testing process may be performed to determine whether the re-trained updated inference model provides the consistent and accurate responses to the set of prompts. If the re-trained updated inference model generates the consistent and accurate responses, the re-trained updated inference model may be used as the compliant inference model. The compliant inference model may be used to provide the computer-implemented services.

If the re-trained updated inference model does not provide the consistent and accurate responses, additional training and/or untraining processes may be performed for the re-trained updated inference model to increase a likelihood that the re-trained updated inference model generates the consistent and accurate responses to the set of prompts.

By doing so, embodiments disclosed herein may improve processes of evaluating knowledge bases of inference models so that responses generated by the inference models may have an increased likelihood of being trustworthy for use in providing computer-implemented services to downstream consumers. By identifying portions of training data that have an increased likelihood of being unintentionally untrained for, testing procedures may selectively test the inference model's ability to generate responses based on an information content of the identified portions of the training data. By doing so, uptime of the inference model may be increased and a resource expenditure during untraining, re-training, and/or evaluation may be reduced.

To provide the above noted functionality, the system of FIG. 1 may include downstream consumers 100, local resource 102, remote resource 106, and communication system 104. Each of these components is discussed below.

Downstream consumers 100 may provide and/or consume all, or a portion of, the computer-implemented services. Downstream consumers 100 may include any number of downstream consumers (e.g., 100A, 100N) and may include, for example, businesses, individuals, and/or devices (e.g., data processing systems) that may obtain responses and/or other information based on the responses as part of receiving the computer-implemented services.

Downstream consumers 100 may subscribe to computer-implemented services provided, at least in part, by local resource 102 and local resource 102 may interact with any number of other entities (e.g., remote resource 106) as part of providing the computer-implemented services. For example, remote resource 106 may provide inferencing services to local resource 102 and local resource 102 may use inferences (e.g., responses) generated by inference models hosted by remote resource 106 as part of the computer-implemented services provided to downstream consumers 100. Local resource 102 may also host inference models locally which may provide the responses used by local resource 102 in the provision of the computer-implemented services.

Remote resource 106 may manage any number of inference models and may be owned by a second owner (e.g., a third-party entity). For example, remote resource 106 may train, and/or host (e.g., operate) generative AI models and may provide inferencing services to any number of other entities. However, the inference models (e.g., the generative AI models) may be updated (e.g., retrained, untrained) over time to improve a quality of the computer-implemented services (e.g., by remote resource 106, by local resource 102). To do so, untraining and/or evaluation processes for the inference models may be performed prior to providing computer-implemented services based on responses received from the inference models.

Local resource 102 may include any entity that provides, at least in part, computer-implemented services to downstream consumers 100. Local resource 102 may be owned by a first owner. The first owner may not control remote resource 106, and/or local resource 102 and remote resource 106 may be controlled by a single entity (e.g., the first owner and the second owner may be the same entity). To provide its functionality, local resource 102 may: (i) train (e.g., using training data, using supplemental training data, using other training data), untrain, and/or host any number of inference models, (ii) perform consistency evaluations of inference models to determine whether the inference models provide consistent responses to a set of prompts, (iii) perform accuracy evaluations of inference models to determine whether the inference models provide accurate responses to the set of prompts (e.g., indicating the inference models have a desired knowledge base), and/or (iv) perform other actions.

For example, local resource 102 may perform consistency and/or accuracy evaluations during inference model training and/or untraining procedures to determine whether inference models are compliant inference models (e.g., an inference model usable to provide the computer-implemented services as desired). The inference models may include inference models trained, at least in part, using a set of training data that may include undesirable training data. The undesirable training data may include: (i) proprietary training data (e.g., confidential to an entity that owns the proprietary training data), (ii) poisoned training data (e.g., generated by a malicious entity) and/or other types of training data that are unsuitable for use during inference generation.

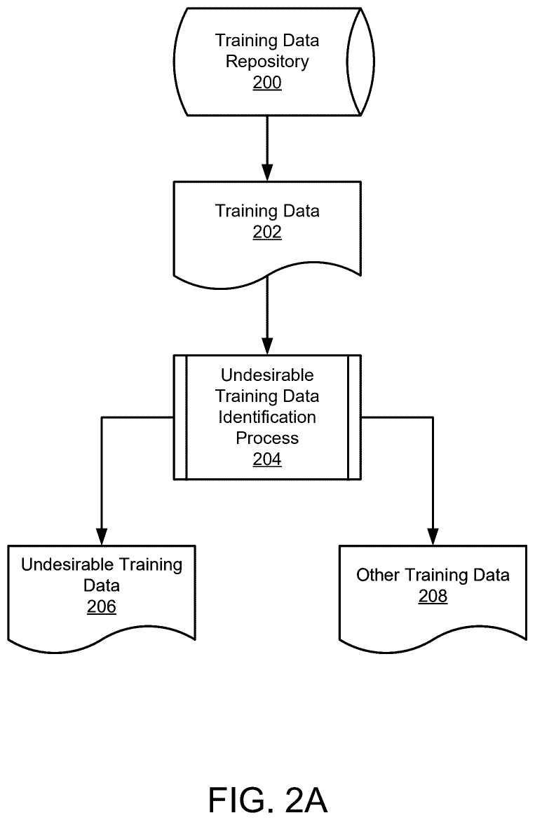

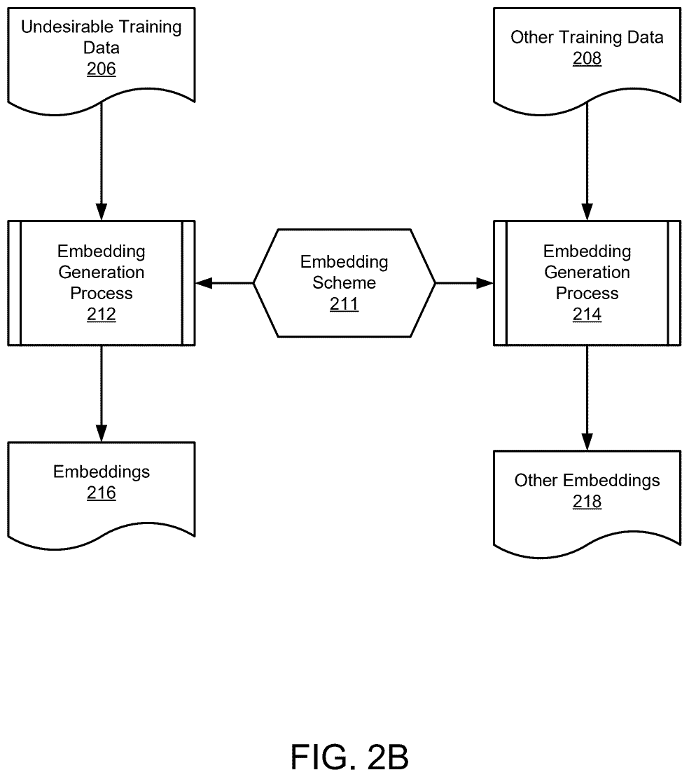

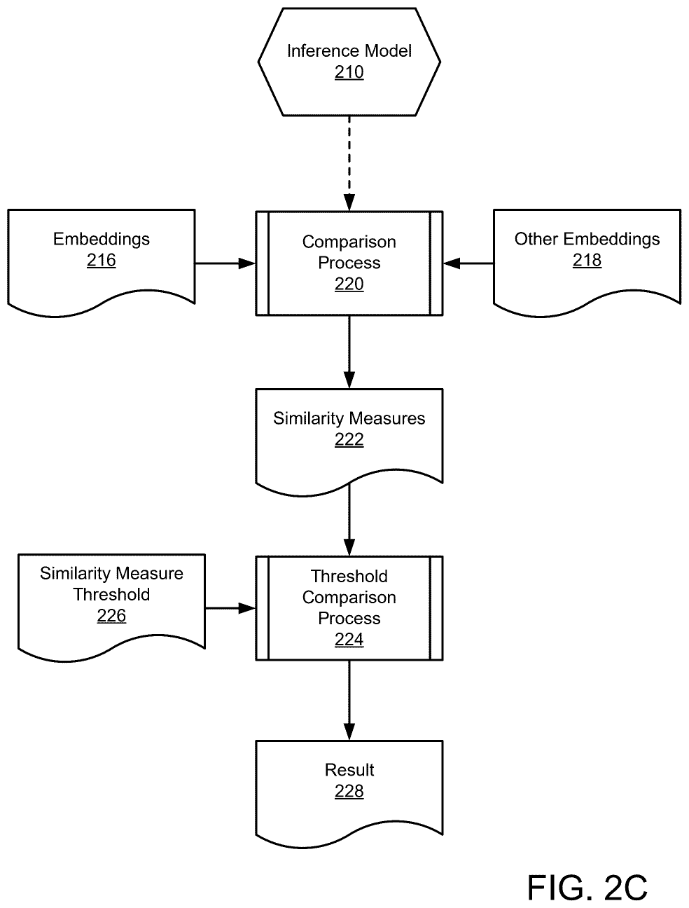

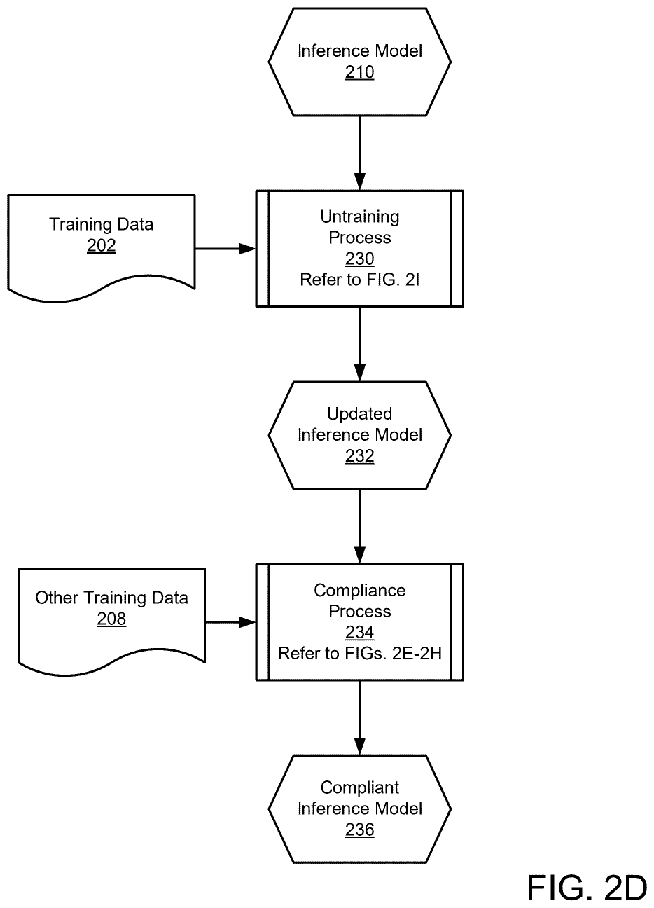

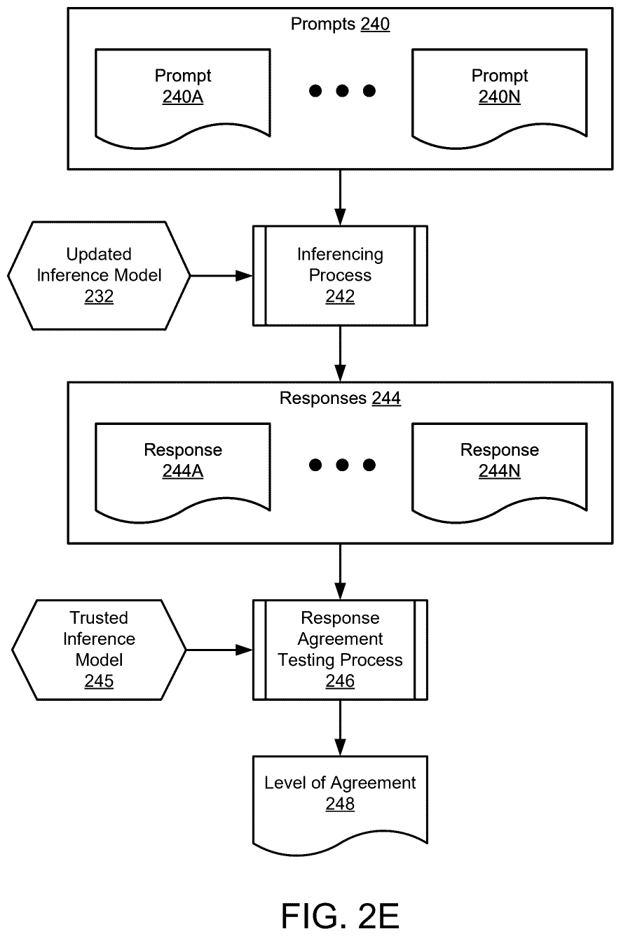

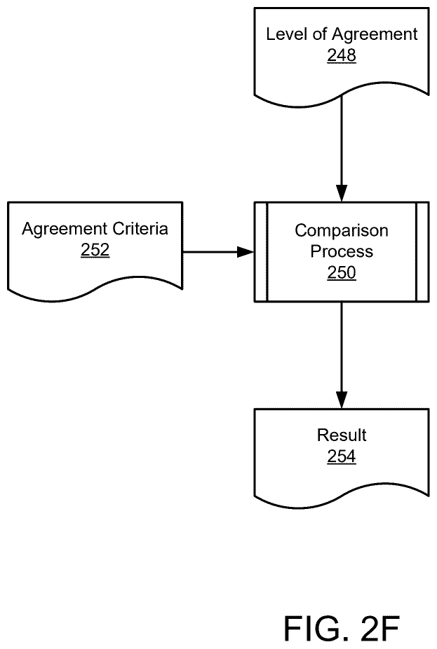

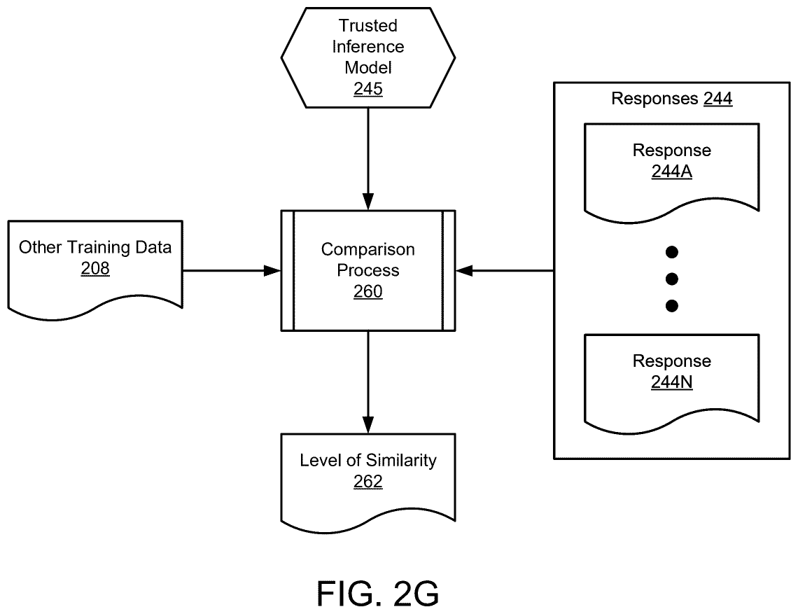

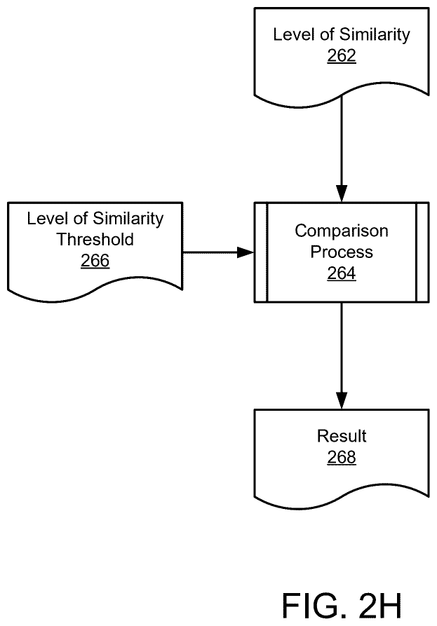

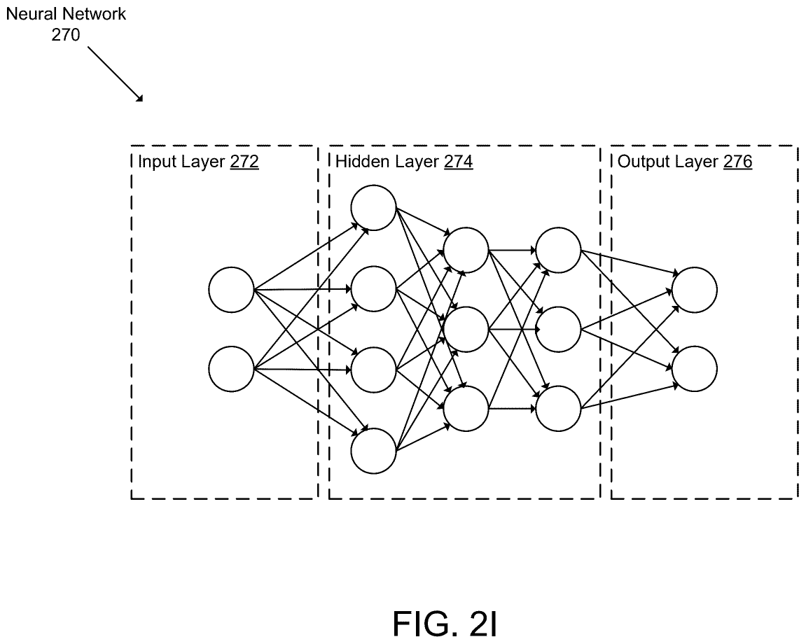

To perform its functionality, local resource 102 may: (i) identify a portion of training data that was used to train an inference model and is undesirable, and/or (ii) perform a similarity analysis on the portion of the training data and other portions of the training data to identify whether any of the other portions of the training data have similar embeddings to the portion of the training data. While described with respect to comparing embeddings, it may be appreciated that the information content of the portion of the training data and the other portions of the training data may be compared to make the determination rather than comparing the embeddings. Refer to FIG. 2B for additional details regarding embeddings for portions of the training data.

If any of the other portions of the training data have the similar embeddings to the portion of the training data, local resource 102 may: (i) perform an untraining of the inference model using the portion of the training data to obtain an updated inference model and/or (ii) perform a compliance process for the updated inference model using the any of the other portions of the training data to obtain a compliant inference model that reflects relationships defined by the any of the other portions of the training data.

If the any of the other portions of the training data do not have the similar embeddings to the portion of the training data, the inference model may be untrained using the portion of the training data to obtain the compliant inference model.

Performing the untraining may include modification of weights, biases, and/or other mutable aspects of the inference model in order to reduce the inference model's ability to make predictions based on relationships included in the portion of the training data for which the untraining is performed (e.g., via gradient ascent with respect to inference error).

To perform the compliance process, local resource 102 may: (i) obtain, based on the any of the other portions of the training data that have the similar embeddings to the portion of the training data, a set of prompts intended to elicit responses that have a same information content as an information content of the any of the other portions of the training data that have the similar embeddings, and/or (ii) perform, using the set of prompts, a first testing process to determine whether the updated inference model provides consistent and accurate responses to the set of prompts. Refer to FIGS. 2E-2H for additional details regarding the first testing process.

If the updated inference model provides the consistent and accurate responses, local resource 102 may conclude that the updated inference model is the compliant inference model.

If the updated inference model does not provide the consistent and accurate responses, local resource 102 may: (i) perform, using the any of the other portions of the training data, a re-training process for the updated inference model to obtain a re-trained updated inference model, and/or (ii) perform, using the set of prompts, a second testing process to determine whether the re-trained updated inference model provides the consistent and accurate responses. The second testing process may include processes similar to those described with respect to the first testing process (e.g., in FIGS. 2E-2H).

If the re-trained updated inference model provides the consistent and accurate responses, local resource 102 may conclude that the re-trained updated inference model is the compliant inference model. If the re-trained updated inference model does not provide the consistent and accurate responses, local resource 102 may perform additional training and/or untraining for the re-trained updated inference model to increase a likelihood that a further updated inference model provides the consistent and accurate responses to the set of prompts.

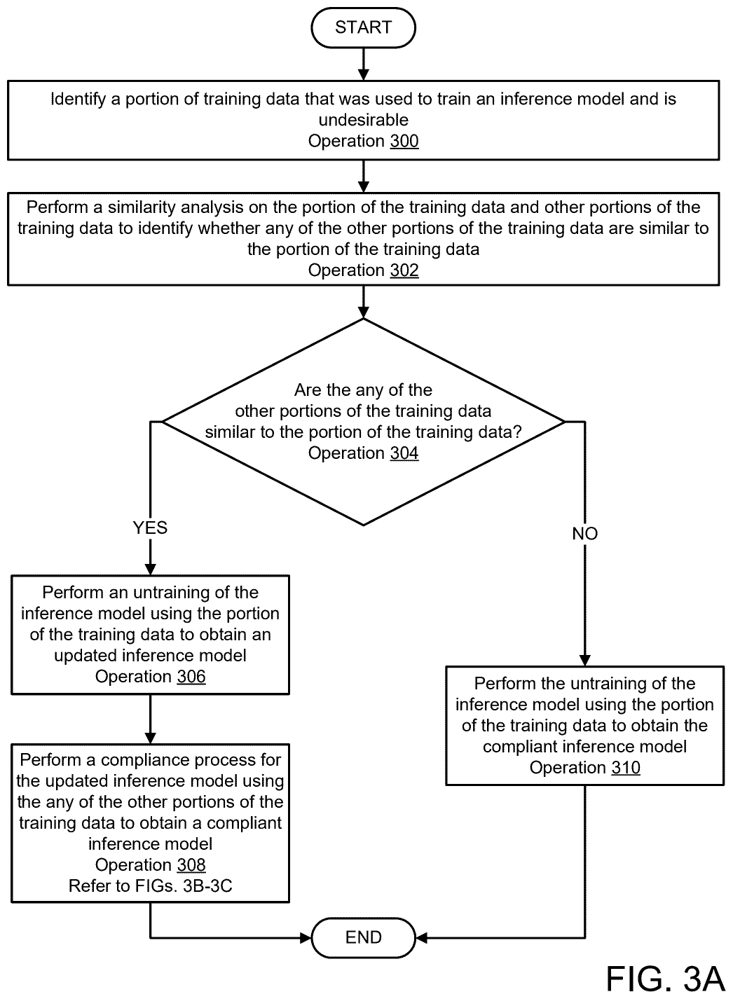

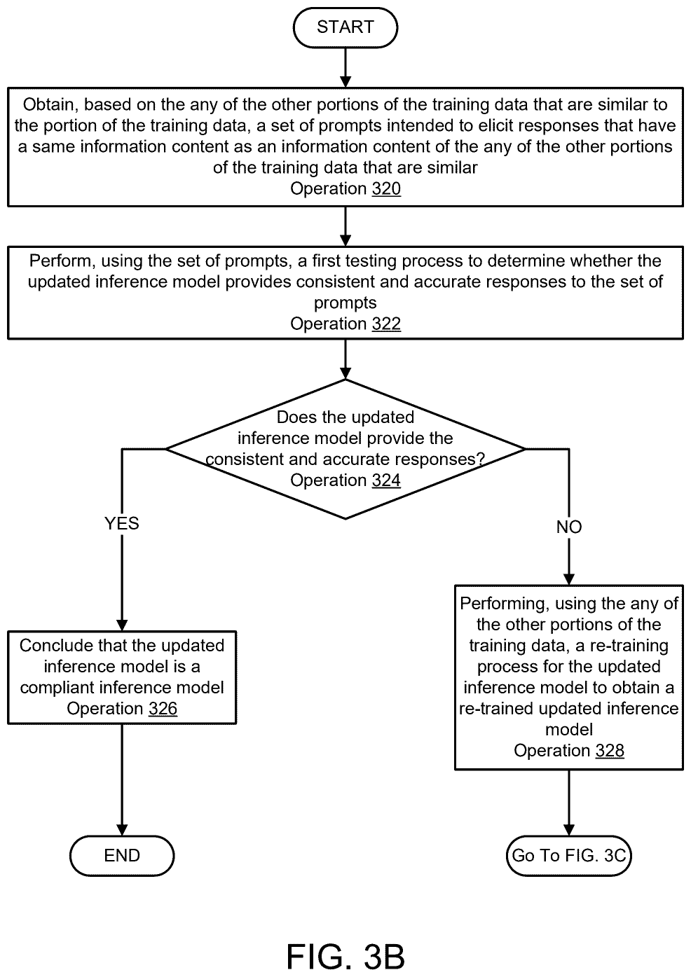

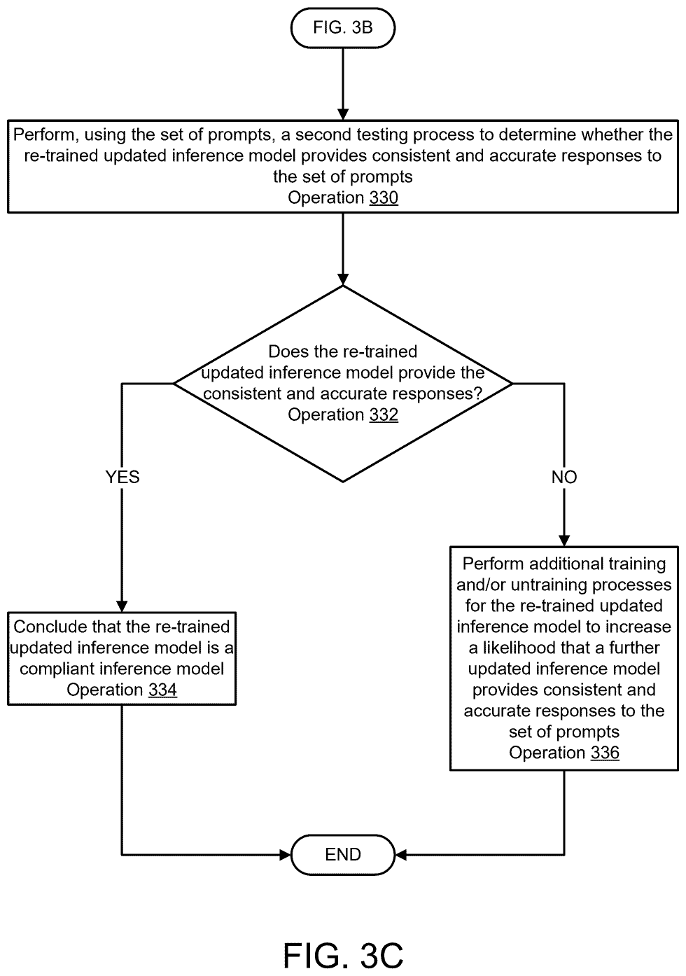

When providing their functionality, any of (and/or components thereof) downstream consumers 100, local resource 102, and/or remote resource 106 may perform all, or a portion, of the actions and methods illustrated in FIGS. 2A-3C.

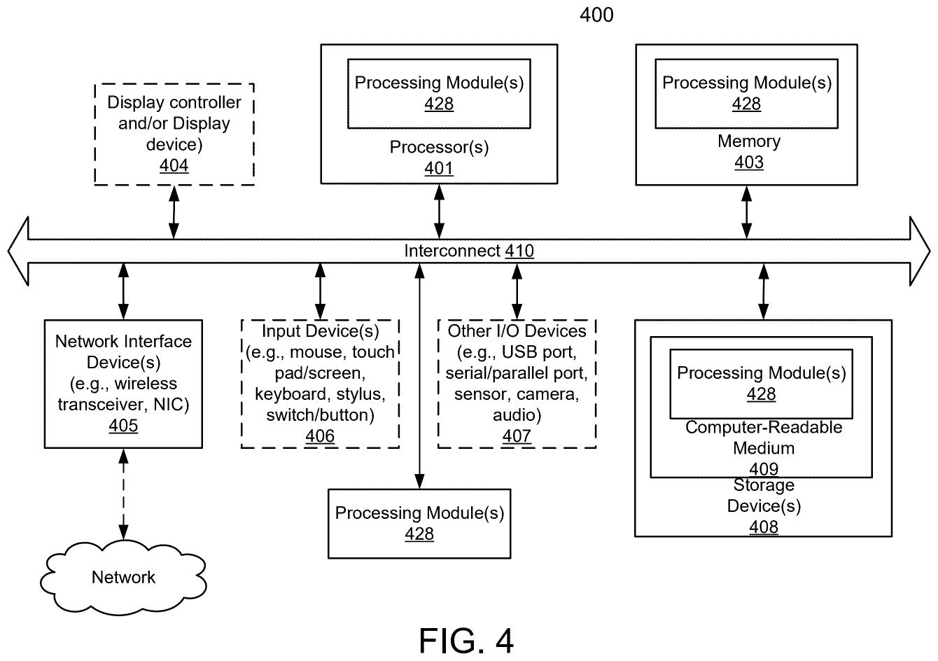

Any of (and/or components thereof) downstream consumers 100, local resource 102, and remote resource 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage inference models to improve availability and/or quality of computer-implemented services provided to downstream consumers of the computer-implemented services. The following processes described in FIGS. 2A-2H may be performed by the system in FIG. 1 when providing this functionality.

To further clarify embodiments disclosed herein, data flow diagrams in accordance with an embodiment are shown in FIGS. 2A-2H. In these diagrams, flows of data and processing of data are illustrated using different sets of shapes. A first set of shapes (e.g., 202, 206, etc.) is used to represent data structures, a second set of shapes (e.g., 204, 212, etc.) is used to represent processes performed using and/or that generate data, a third set of shapes (e.g., 200) is used to represent large scale data structures such as databases, and a fourth set of shapes (e.g., 210, 232) is used to represent inference models and/or other types of models.

Turning to FIG. 2A, a first data flow diagram in accordance with an embodiment is shown. The first data flow diagram may illustrate data used in and data processing performed in identifying that a portion of training data used to train an inference model (e.g., training data 202) is undesirable (e.g., undesirable training data 206).

To identify that a portion of the training data used to train an inference model is undesirable, undesirable training data identification process 204 may be performed. To do so, training data 202 may be obtained (e.g., extracted, requested, read) from training data repository 200. Training data repository 200 may include any quantity of training data and/or sets of training data used to train any number of inference models (e.g., LLMs). Training data stored in training data repository 200 may be labeled according to which inference models they were used to train and, therefore, performing a lookup in in training data repository 200 using an identifier for an inference model as a key for a lookup table may return a set of training data used to train the inference model associated with the identifier. Training data repository 200 may be organized in any other manner and training data 202 may be obtained from training data repository 200 via other methods without departing from embodiments disclosed herein.

Training data 202 may include a set of training data that was previously used to train an inference model. The inference model may be an LLM and, therefore, may be trained using unstructured data, such as stories, essays, audio transcription, video description, other types of human interpretable text, and/or other modalities of data (e.g., video, audio) to generate responses of the same. Thus, training data 202 may include any amount and any type of training data (e.g., unstructured, labeled, unlabeled).

During undesirable training data identification process 204, undesirable training data 206 may be identified. Consider a scenario in which an entity that manages training of inference models (e.g., local resource 102 described in FIG. 2A, another entity) learns that undesirable training data may be present in training data repository 200. Undesirable training data 206 may include: (i) poisoned training data including malicious relationships established by a malicious entity, (ii) proprietary training data including confidential relationships ascribed to an owner of the proprietary training data, and/or (iii) any other sensitive, private, and/or other data that may not be usable for inference generation.

Poisoned training data may include false, harmful, conspiratorial, and/or otherwise unreliable relationships generated by the malicious entity. The malicious entity may be intending to manipulate the inference model and/or inferences (e.g., responses) generated by the inference model via injection of the poisoned training data. The proprietary training data may include information desired to be kept confidential by a first party (e.g., the owner of the proprietary training data) and use of the proprietary training data to train an inference model may increase a risk of exposure and/or unauthorized use of the proprietary information during inference generation.

For example, information may be collected from particular data sources to add to training data repository 200 and one of the data sources may revoke privileges for information collection and/or one of the data sources may be revealed to be a poisoned data source.

Once it has been established that undesirable training data may have been added to training data repository 200, it may be determined whether an inference model was trained using any of the undesirable training data prior to generating inferences (e.g., responses) using the inference model. Inferences generated using the inference model may be unreliable, may be based on the malicious relationships, may be based on the proprietary information, and/or may otherwise reduce a quality of the computer-implemented services if the inference model was trained using, at least in part, the undesirable training data.

During undesirable training data identification process 204, undesirable training data 206 may be filtered from training data 202 using, for example, search terms to identify particular types of data, particular information content of data, a particular data source that is known to be poisoned, and/or using other key words. Other training data 208 may include portions of training data 202 that were not identified as including undesirable training data.

Turning to FIG. 2B, a second data flow diagram in accordance with an embodiment is shown. The second data flow diagram may illustrate data used in and data processing performed during obtaining embeddings for portions of training data that was used to train an inference model.

To obtain the embeddings for the portions of the training data, embeddings generation process 212 may be performed using undesirable training data 206 and embeddings generation process 214 using other training data 208.

During embeddings generation process 212, embedding scheme 211 may ingest undesirable training data 206 and embeddings 216 may be obtained as at least a portion of an output from embedding scheme 211. Embedding scheme 211 may include a generative AI model (e.g., an LLM) trained to generate language, understand language, and/or otherwise process requests related to languages. Embedding scheme 211 may include other types of models trained to generate embeddings when given input data, any type of rule set or algorithm for generating embeddings, and/or may otherwise include instructions for generation of embeddings.

For example, embedding scheme 211 may include a neural network inference model that includes: (i) at least one input layer, (ii) any number of hidden layers, and (iii) at least one output layer. To generate embeddings 216, at least one layer (e.g., an input layer, a hidden layer) of the neural network inference model may include an embedding layer. The nodes of the embedding layer may correspond to dimensions of an embedding space to which undesirable training data 206 is to be mapped. Specifically, the embeddings may be generated by an embedding layer and the embeddings may be extracted via obtaining an output from any layer following (or including) the embedding layer. For example, the embeddings may be obtained as an output from a second to last layer of the neural network (e.g., the last hidden layer prior to an output layer). Embeddings 216 may be generated using other techniques and/or using other inference models without departing from embodiments disclosed herein.

Embeddings 216 may include latent representations (e.g., reduced-size representations, vector representations including a set of numbers) of undesirable training data 206. Representing undesirable training data 206 as a series of embeddings may allow for identification of portions of other training data 208 that have similar embeddings to embeddings 216 and, therefore, may be vulnerable to unintentional untraining if an inference model is untrained based on embeddings 216.

Embedding generation process 214 may include processes similar to embedding generation process 212. In brief, other embeddings 218 may be obtained via ingestion by inference model 210 and/or other methods. Other embeddings 218 may include latent representations (e.g., reduced-size representations, vector representations including a set of numbers) of other training data 208.

While described above with respect to obtaining embeddings 216 and other embeddings 218 using an LLM (e.g., of embedding scheme 211), it may be appreciated that embeddings 216 and other embeddings 218 may be obtained using other methods (e.g., other models, algorithms, schemas of embedding scheme 211) without departing from embodiments disclosed herein.

In addition, an information content of undesirable training data 206 and other training data 208 may be identified during embedding generation process 212 and embedding generation process 214 respectively (and/or during other processes to extract information content from the training data) (not shown). The information content of undesirable training data 206 and the information content of other training data 208 may be usable to identify whether any of the information content of undesirable training data 206 matches any of the information content of other training data 208 thereby indicating that a portion of good training data may have been unintentionally untrained on.

Turning to FIG. 2C, a third data flow diagram in accordance with an embodiment is shown. The third data flow diagram may illustrate data used in and data processing performed during identifying whether any embeddings of training data that has an information content that is to be retained with a knowledge base of an inference model are similar to embeddings of training data that have an information content that is to be removed from the knowledge base of the inference model. While described in FIG. 2C as comparing embeddings 216 and embeddings 218, it may be appreciated that an information content of the undesirable training data and an information content of the other training data may be compared without departing from embodiments disclosed herein.

Embeddings 216 may include information content that is desired to be removed from a knowledge base of inference model 210 and other embeddings 218 may include information content that is desired to be retained with the knowledge base of inference model 210. Refer to the description of FIG. 2B for additional details regarding embeddings 216 and other embeddings 218.

Inference model 210 may include a generative AI model (e.g., an LLM) trained to generate language, understand language, and/or otherwise process requests related to languages. The generative AI model may include, for example, a neural network inference model. Inference model 210 may have been previously trained using training data 202 using any training process (e.g., a global optimization process using gradient descent), training data 202 indicating goals for outputs generated by inference model 210 (e.g., responses). Parameters of inference model 210 may be selected using an optimization process (e.g., an objective function may be defined in terms of training data 202 and responses generated by inference model 210, and a global optimization method such as gradient descent may be used to identify parameters that most faithfully reproduce the trends in training data 202). Once the parameters of inference model 210 are set, then inference model 210 may be used to generate responses based on input data (e.g., prompts).

Inference model 210 may be trained using other methods without departing from embodiments disclosed herein.

To determine whether any of other embeddings 218 are similar to embeddings 216, comparison process 220 may be performed. During comparison process 220, inference model 210 may be used to compare numerical values corresponding to the latent representations of embeddings 216 to numerical values corresponding to the latent representations of embeddings 216 to obtain similarity measures 222. The line connecting inference model 210 to comparison process 220 in FIG. 2C is shown as a dashed line to indicate that inference model 210 may be used as part of comparison process 220 and/or other methods may be used to compare the numerical values. For example, another inference model, a rule set, an algorithm, and/or another method may be used to compare the numerical values.

Similarity measures 222 may include any number of representations of degrees of similarity between embeddings 216 and other embeddings 218. During comparison process 220, each embedding of other embeddings 218 (e.g., each numerical latent representation) may be compared to each embedding of embeddings 216. Similarity measures 222 may include a similarity measure for each embedding of other embeddings 218.

For example, each similarity measure of similarity measures 222 may: (i) be associated with an embedding of other embeddings 218, (ii) identify an embedding of embeddings 216 with which the embedding of other embeddings 218 is the most similar, (iii) include a score indicating an extent to which the embedding of other embeddings 218 is similar to the embedding of embeddings 216. The score may include a percentage, a number on a scale, and/or any other representation of the extent of the similarity between the embeddings.

In addition, during comparison process 220, an information content of the undesirable training data may be compared to an information content of other training data (and/or known good information content) to identify any portions of the undesirable training data that may have been erroneously included as undesirable (e.g., may include good training data).

To determine whether any of other embeddings 218 are similar to embeddings 216 to an extent that an untraining process may impact them, threshold comparison process 224 may be performed. During threshold comparison process 224, each similarity measure of similarity measures 222 may be compared to similarity measure threshold 226 to determine whether any of similarity measures 222 meet similarity measure threshold 226. Similarity measure threshold 226 may include a quantity that corresponds to the score included in each similarity measure. If a similarity measure of similarity measures 222 meets similarity measure threshold 226, the similarity measure may indicate that an embedding of other embeddings 218 is sufficiently similar to at least one embedding of embeddings 216 to be vulnerable to unintentional untraining (e.g., when an untraining is performed using undesirable training data 206 from which embeddings 216 were obtained). If a similarity measure of similarity measures does not meet similarity measure threshold 226, the embedding of other embeddings 218 corresponding to the similarity measure may not be considered vulnerable during the untraining.

Result 228 may be obtained as a result of threshold comparison process 224. Result 228 may include a list of other embeddings 218 (and/or corresponding portions of other training data 208) with corresponding similarity measures that meet similarity measure threshold 226.

Therefore, if inference model 210 (and/or any other inference model trained using training data 202) is untrained with respect to undesirable training data 206 (e.g., including both good and bad training data), inference model 210 may also be unintentionally untrained with respect to any of other embeddings 218 identified by result 228. By doing so, inference model 210 may have an unintentionally reduced ability to generate responses based on an information content of undesirable training data 206 and any portion of other training data 208 identified by result 228. If it is found that inference model 210 has a reduced ability to generate the responses based on the erroneously included good training data, inference model may be re-trained with respect to the erroneously included good training data (Refer to FIGS. 2D-2H).

Turning to FIG. 2D, a fourth data flow diagram in accordance with an embodiment is shown. The fourth data flow diagram may illustrate data used in and data processing performed during obtaining a compliant inference model (e.g., compliant inference model 236).

To obtain compliant inference model 236, untraining process 230 and compliance process 234 may be performed.

During untraining process 230, weights, biases, and/or other characteristics of inference model 210 may be modified, using training data 202, to reduce an ability of inference model 210 to generate responses to prompts based on undesirable training data 206 (e.g., via a gradient ascent process with respect to inference error for an objective function used during untraining). Refer to FIG. 2I for additional details regarding the untraining process. Untraining process 230 may include any other untraining process without departing from embodiments disclosed herein.

As a result of untraining process 230, updated inference model 232 may be obtained. Updated inference model 232 may be a generative AI model (e.g., an LLM) trained to generate language, understand language, and/or otherwise process requests related to languages. The generative AI model may include, for example, a neural network inference model.

Following untraining process 230, a testing process may be performed (not shown) to determine whether updated inference model 232 is sufficiently untrained with respect to undesirable training data 206. Refer to FIG. 2I for details regarding this testing process.

To obtain compliant inference model 236, compliance process 234 may be performed using at least other training data 208. During compliance process 234, a set of prompts may be obtained that are intended to elicit responses that have a same information content as an information content of other training data 208 (e.g., an information content that was desired to be retained with a knowledge base of inference model 210 following untraining process 230) and a first testing process may be performed to determine whether updated inference model 232 provides consistent and accurate responses to the set of prompts. Refer to FIGS. 2E-2H for additional details regarding the first testing process.

If updated inference model 232 provides the consistent and accurate responses, updated inference model 232 may be promoted to compliant inference model 236. Compliant inference model 236 may be considered sufficiently untrained with respect to undesirable training data 206 and sufficiently trained with respect to other training data 208 (e.g., may retain an information content of other training data 208 following untraining). Therefore, compliant inference model 236 may reflect relationships defined by other training data 208 during inference generation.

If updated inference model 232 does not provide the consistent and accurate responses, a re-training process may be performed as part of compliance process 234. During the re-training process, other training data 208 may be used to train updated inference model using any training methodology. For example, a gradient descent process may be used to modify weights and/or other mutable characteristics of updated inference model 232 to increase an ability of updated inference model 232 to faithfully reproduce relationships included in other training data 208.

Following the re-training process, a re-trained inference model may be obtained (not shown). A second testing process may be performed to determine whether the re-trained updated inference model provides the consistent and accurate responses to the set of prompts. The second testing process may include processes similar to those described with respect to the first testing process using the re-trained updated inference model in place of updated inference model 232.

Refer to FIGS. 2E-2H for additional details regarding the first testing process.

If the re-trained updated inference model provides the consistent and accurate responses, the re-trained updated inference model may be promoted to compliant inference model 236. If the re-trained updated inference model does not provide the consistent and accurate responses, additional training and/or untraining processes (e.g., similar to untraining process 230 and the re-training process described above) may be performed to obtain a further updated inference model. Additional testing processes similar to the first testing process and the second testing process may also be performed until compliant inference model 236 is obtained.

Thus, by implementing the data flows shown in FIG. 2A-2D, a system in accordance with embodiments disclosed herein may be used to obtain a compliant inference model based on an existing inference model. By testing an untrained inference model (e.g., updated inference model 232) with respect to a subset of the training data (e.g., other training data 208) a resource expenditure associated with testing the knowledge base of the inference model may be reduced. Consequently, downtime for the inference model may also be reduced thereby increasing a likelihood of providing the computer-implemented services as desired to a downstream consumer.

Turning to FIG. 2E, a fifth data flow diagram in accordance with an embodiment is shown. The fifth data flow diagram may illustrate data used in and data processing performed in performing a portion of a first testing procedure to determine whether an updated inference model provides consistent and accurate responses to a set of prompts. The processes shown in FIG. 2E may be a partial expansion of compliance process 234 shown in FIG. 2D.

To perform the first testing procedure, inferencing process 242 may be performed using prompts 240. Prompts 240 may be obtained, for example, via: (i) generation by a SME, (ii) generation by a third inference model (not shown), and/or (iii) other methods. The third inference model (not shown) may also be a generative AI model (e.g., a third LLM).

Prompts 240 may be a set of prompts including any number of prompts (e.g., 240A-240N) that may be adapted to elicit responses from inference models including information content intended to be retained with a knowledge base of updated inference model 232 (e.g., from other training data 208 described in FIG. 2A). Prompt 240A, for example, may include human-interpretable text and may include a question to be answered by updated inference model 232. Prompt 240A may: (i) include a solicitation for a same information content (e.g., as other prompts of prompts 240), and (ii) use a different phrasing from phrasings used by the other prompts of prompts 240.

For example, updated inference model 232 may have been untrained for a portion of the training data (e.g., undesirable training data 206 described in FIG. 2A) that includes news articles generated by a news entity via an untraining process such as untraining process 230 described in FIG. 2D. Following untraining process 230, updated inference model 232 may be intended to retain information content from other training data 208. The other information content may include news articles from other entities.

To test whether a knowledge base of updated inference model 232 has the other information content, prompt 240A may include a solicitation (e.g., question) for updated inference model 232 to provide a summary of a news article from one of the other entities using a first phrasing. Prompt 240B may include a second solicitation for updated inference model 232 to provide the summary of the news article (e.g., the same information content) using a second phrasing.

The first phrasing may include human-interpretable text such as “what did entity C say about topic B” and the second phrasing may include human-interpretable text such as “explain topic B.” For example, in the first phrasing and the second phrasing, topic B may include opinions and/or other content exclusive to news entity A. Therefore, if updated inference model 232 provides a summary of topic B, it may be concluded that updated inference model 232 is trained using the content exclusive to news entity A. Other prompts of prompts 240 may include other phrasings. However, each prompt of prompts 240 may be intended to elicit the same information content that includes the summary of the news article from the one of the other entities.

During inferencing process 242, prompts 240 may be provided to updated inference model 232. During inferencing process 242, prompts 240 may be fed into updated inference model 232 and responses 244 may be obtained from updated inference model 232. Responses 244 may include any number of responses (e.g., 244A-244N). Each response of responses 244 may be responsive to a prompt of prompts 240. For example, response 244A may be responsive to prompt 240A. If updated inference model 232 is hosted by the remote resource, responses 244 may be obtained from the remote resource (e.g., by the local resource, by the first owner) in response to prompts 240.

Responses 244 may include at least a first response (e.g., response 244A) with a first information content and a second response (e.g., response 244B) with a second information content. Continuing with the above example where prompts 240 may include requests for summaries of news articles, the first information content and the second information content may be intended to include the summaries. Updated inference model 232 may be provided (e.g., as part of prompts 240, prior to inferencing process 242) with additional contextual information, specific graphical user interfaces (GUIs), and/or other information to narrow a scope of responses 244 to an application relevant to a downstream consumer of responses 244.

To evaluate agreement between responses of responses 244, response agreement testing process 246 may be performed. During response agreement testing process 246, responses 244 and a second LLM trained to compare information content of data structures provided as ingest (e.g., responses 244), such as trusted inference model 245, may be used to obtain level of agreement 248. Trusted inference model 245 may be deemed consistent and accurate and may be inference model 210 (e.g., if inference model 210 is not poisoned and is considered consistent and accurate) and/or may include another inference model. To do so, a response agreement testing prompt (not shown) may be provided to inference model 210.

The response agreement testing prompt may include: (i) responses 244, (ii) instructions for comparing information content of responses 244, and/or (iii) other information such as contextual information usable to compare responses 244. For example, the response agreement testing prompt may instruct trusted inference model 245 to: (i) determine whether at least response 244A and response 244B seem to be responsive to a same prompt (e.g., question), (ii) determine whether response 244A and response 244B seem to have a same information content, and/or (iii) otherwise compare responses 244.

During response agreement testing process 246, an output may be obtained from trusted inference model 245 in response to providing the agreement testing prompt to trusted inference model 245. The output may include level of agreement 248 and/or may include information usable to obtain level of agreement 248. For example, the information usable to obtain level of agreement 248 may include: (i) a list of responses of responses 244 that trusted inference model 245 considers as having a same information content, (ii) a list of prompts of prompts 240 that trusted inference model 245 considers equivalent (e.g., via determining that responses to the prompts have a same information content), and/or (iii) other information. Therefore, during response agreement testing process 246, level of agreement 248 may be obtained (e.g., by reading the levels of agreement from the output, by analyzing and/or processing the output to obtain the levels of agreement).

Level of agreement 248 may indicate degrees of similarity between responses of responses 244 (e.g., between at least response 244A and response 244B). For example, level of agreement 248 may include: (i) a number of responses 244 that trusted inference model 245 considers equivalent (e.g., shown as a number and/or as a percentage), (ii) a number of responses 244 that trusted inference model 245 considers to be answers to a same prompt (e.g., shown as a number and/or as a percentage), and/or (iii) other quantifications of the degree of similarity.

Turning to FIG. 2F, a sixth data flow diagram in accordance with an embodiment is shown. The sixth data flow diagram may illustrate data used in and data processing performed in performing a portion of a first testing procedure to determine whether an updated inference model provides consistent and accurate responses to a set of prompts. The processes shown in FIG. 2F may be a partial expansion of compliance process 234 shown in FIG. 2D.

To determine whether updated inference model 232 provides the consistent responses to prompts 240, comparison process 250 may be performed. During comparison process 250, it may be determined whether level of agreement 248 (e.g., described in FIG. 2E) meets agreement criteria 252.

Agreement criteria 252 may be based on a level of ability of updated inference model 232 to utilize other information content from other training data that was to be retained following the untraining process (e.g., untraining process 230). The level of ability may be based on any threshold indicated by agreement criteria 252. Having the level of ability may indicate that updated inference model 232 has a sufficiently high ability to utilize the other information content (e.g., of the portion of the training data that was desired to be retained with the knowledge base of inference model 210).

If a quantity included in level of agreement 248 meets a corresponding threshold of agreement criteria 252, it may be concluded that updated inference model 232 provides sufficiently consistent responses to the second set of prompts. If the quantity included in level of agreement 248 does not meet the second corresponding threshold of agreement criteria 252, it may be concluded that updated inference model 232 does not provide the sufficiently consistent responses to the second set of prompts.

For example, level of agreement 248 may indicate that 83% of responses 244 are considered to have a same information content and agreement criteria 252 may include a second threshold quantity of at least 75% of responses having the same information content to be considered sufficiently consistent. Therefore, in this example, level of agreement 248 may meet agreement criteria 252.

While described above with respect to a single quantity and a single corresponding threshold, it may be appreciated that any number of quantities may be compared to any number of corresponding thresholds and/or any other types of rules may be applied to determine whether agreement criteria 252 are met.

As a result of comparison process 250, result 254 may be obtained. Result 254 may include an indication of whether updated inference model 232 provides the inconsistent responses. For example, result 254 may include a “yes” or “no” answer, may include any quantities of level of agreement 248, and/or may include other information.

If result 254 indicates that updated inference model 232 does not provide the consistent responses (e.g., responses 244 were deemed inconsistent), a re-training process for updated inference model 232 may be performed to improve a likelihood that a further untrained prototype inference model based on updated inference model 232 provides the consistent responses. Refer to the description of FIG. 2D for additional details regarding performing the re-training process.

If result 254 indicates updated inference model 232 does provide the consistent responses, it may indicate that the information content of the other training data of training data 202 has been retained with the knowledge base of updated inference model 232. The first testing procedure may then be continued to determine whether updated inference model 232 provides accurate responses to the set of prompts.

In addition, while described in FIGS. 2E-2F as obtaining level of agreement 248 from trusted inference model 245 and performing comparison process 250 using level of agreement 248 and agreement criteria 252, it may be appreciated that trusted inference model 245 may also perform at least a portion of comparison process 250 and an output from trusted inference model 245 during response agreement testing process 246 may include a determination of whether updated inference model 232 provides the consistent responses.

Following obtaining result 254 (and/or at other times such as prior to performing comparison process 250), additional testing processes may be performed to further interrogate responses of responses 244 that were determined to not be equivalent during response agreement testing process 246. For example, a first response (e.g., response 244A) and a second response (e.g., response 244B) may be determined to not be equivalent by trusted inference model 245. In response, trusted inference model 245 may be prompted to explain a difference between response 244A and response 244B. Trusted inference model 245 may generate a second output and the second output may include a description of the difference between response 244A and response 244B as determined by trusted inference model 245. The second output may be evaluated (e.g., by an SME, by another entity, by a different inference model) to determine whether to retain or change a status of response 244A and response 244B being non-equivalent.

Turning to FIG. 2G, a seventh data flow diagram in accordance with an embodiment is shown. The seventh data flow diagram may illustrate data used in and data processing performed in performing, at least in part, the first testing procedure for updated inference model 232. The first testing procedure may include attempting to verify whether updated inference model 232 provides accurate responses to the set of prompts (e.g., prompts 240). To do so, an information content of a set of responses (e.g., responses 244) from updated inference model 232 may be compared to other information content of other training data of training data 202 that is desired to be retained with the knowledge base of updated inference model 232 (e.g., other training data 208).

While it may be determined that updated inference model 232 provides consistent responses to the second set of prompts (e.g., prompts 240) (refer to FIGS. 2E-2F), it may not be concluded whether the knowledge base of updated inference model 232 has the other information content from other training data 208. For example, updated inference model 232 may provide consistent responses to prompts 240 which are inaccurate, incorrect, and/or otherwise erroneous.

Returning to the example where updated inference model 232 is trained using training data that includes news articles from different entities, updated inference model 232 may provide consistent responses to a set of prompts including a solicitation for a summary of a news article. For example, the responses may include summaries with a same first information content. While the responses may include a same first information content, the responses may be inaccurate. For example, the other training data may include articles and/or summaries of articles with a second information content. Thus, updated inference model 232 may provide responses to the second set of prompts which are consistent, yet inaccurate. If the responses are inaccurate, it may be concluded that the knowledge base of updated inference model 232 does not have the other information content.

To determine whether the knowledge base of updated inference model 232 has the information content of other training data 208, comparison process 260 may be performed. During comparison process 260, a first information content of responses 244 may be compared to a second information content of other training data 208. Responses 244 may include a set of responses (e.g., 244A-244N) obtained during inferencing process 242 described in FIG. 2E and may be responsive to a set of prompts (e.g., prompts 240, not shown). The set of prompts may be intended to elicit responses including the second information content of other training data 208. Thus, responses 244 may be considered accurate if the first information content of responses 244 is consistent with (e.g., considered sufficiently the same as) at least a portion of the second information content of other training data 208 based on any criteria.

Comparing the first information content of responses 244 to the second information content of other training data 208 may include: (i) prompting trusted inference model 245 to compare the first information content and the second information content to obtain level of similarity 262, (ii) providing the first information content and the second information content to a SME and or other entity for comparison, and/or (iii) other methods.

Trusted inference model 245 may be prompted to compare the first information content and the second information content by feeding at least responses 244 and at least a portion of other training data 208 into trusted inference model 245. For example, a level of similarity prompt may be provided to trusted inference model 245 (not shown) and the level of similarity prompt may instruct trusted inference model 245 to determine whether responses 244 and other training data 208 seem to have a same information content and/or otherwise compare responses 244 to other training data 208.

During comparison process 260, an output may be obtained from trusted inference model 245 in response to providing the level of similarity prompt trusted inference model 245. The output may include level of similarity 262 indicating an extent of similarity between the first information content and the second information content (not shown) and/or may include information usable to obtain level of similarity 262.

For example, the information usable to obtain level of similarity 262 may include a list of responses of responses 244 that trusted inference model 245 considers as having a same information content as other training data 208 and/or other information. Level of similarity 262 may indicate an extent to which the first information content matches the second information content.

For example, level of similarity 262 may include: (i) a number of responses 244 that trusted inference model 245 considers consistent (e.g., considers as having a same information content) with other training data 208 (e.g., shown as a number and/or as a percentage), and/or (ii) other quantifications of the level of similarity.

Turning to FIG. 2H, an eighth data flow diagram in accordance with an embodiment is shown. The eighth data flow diagram may illustrate data used in and data processing performed in performing, at least in part, the first testing procedure for updated inference model 232. The processes shown in FIG. 2H may be a partial expansion of compliance process 234 shown in FIG. 2D.

To determine whether level of similarity 262 indicates that responses 244 are accurate with respect to the second set of prompts, comparison process 264 may be performed. During comparison process 264, level of similarity 262 may be compared level of similarity threshold 266. Level of similarity threshold 266 may be based on any criteria for accuracy of an inference model and may be obtained from: (i) a SME, (ii) a downstream consumer, (iii) another inference model, (iv) the first owner (e.g., of the local resource), and/or (v) from any other entity and/or source.

Level of similarity threshold 266 may also be based on the level of ability of updated inference model 232 to utilize the other information content from the other training data (e.g., other training data 208 described in FIG. 2A) that was not intended to be untrained for (e.g., untraining process 230) to generate desirable (e.g., consistent and accurate) responses to the set of prompts (e.g., prompts 240 described in FIG. 2E). Consequently, updated inference model 232 may have the level of ability when updated inference model 232 has a sufficiently high ability to utilize the other information content to generate the desirable responses to the second set of prompts (e.g., based on level of similarity threshold 266).

If updated inference model 232 meets the criteria for accuracy (e.g., level of similarity 262 meets level of similarity threshold 266), it may be concluded that updated inference model 232 provides accurate responses to the second set of prompts and thus, has a knowledge base that retains the other information content of the other training data.

For example, level of similarity 262 may include a percentage indicating an extent to which the first information content (e.g., of responses 244 described in FIGS. 2E-2F) is considered consistent with the second information content (e.g., of other training data 208 described in FIG. 2A). Level of similarity 262 may, therefore, indicate that the first information content is 78% similar to the second information content. Level of similarity threshold 266 may indicate that the first information content must be considered to be at least 85% similar to the second information content for updated inference model 232 to be considered consistent with other training data 208 and, therefore, provide accurate responses. Consequently, in this example, updated inference model 232 may not provide the accurate responses.

As a result of comparison process 264, result 268 may be obtained. Result 268 may include a “yes” or “no” designation regarding whether updated inference model 232 provides the accurate responses to the second set of prompts based on the comparison between level of similarity 262 and level of similarity threshold 266.

If result 268 indicates that updated inference model 232 provides the accurate responses, it may be concluded that updated inference model 232 has a knowledge base that retains the other information content of the other training data following the untraining process. Updated inference model 232 may then be used as a compliant inference model (e.g., compliant inference model 236 described in FIG. 2D) and no additional untraining or re-training processes may be performed.

Promoting updated inference model 232 to a compliant inference model (e.g., compliant inference model 236 described in FIG. 2D) may include replacing inference model 210 with compliant inference model 236 for at least a portion of providing the computer-implemented services. Replacing inference model 210 with compliant inference model 236 may include sending prompts to compliant inference model 236 rather than sending prompts to inference model 210 and using responses generated by compliant inference model 236 as part of providing the computer-implemented services.

If result 268 indicates that updated inference model 232 does not provide the accurate responses, a re-training procedure for updated inference model 232 may be performed to obtain a re-trained updated inference model. Refer to the description of FIG. 2D for additional details regarding performing the re-training procedure. Following the re-training procedure, a second testing process may be performed to determine whether the re-trained updated inference model provides the consistent and accurate responses to prompts 240. The second testing process may include methods similar to those described in FIGS. 2E-2H with respect to the first training procedure with the re-trained updated inference model in place of updated inference model 232.

If the re-trained updated inference model provides the consistent and accurate responses, the re-trained updated inference model may be promoted to compliant inference model 236 described in FIG. 2D. If the re-trained updated inference model does not provide the consistent and accurate responses, additional training and/or untraining processes may be performed to increase a likelihood that a further updated inference model provides the consistent and accurate responses.

Thus, by implementing the data flow shown in FIG. 2A-2H, a system in accordance with embodiments disclosed herein may be used to test whether an updated inference model provides consistent and accurate responses to a set of prompts based on other training data with an information content desired to be retained in the knowledge base of the updated inference model. By utilizing another inference model during the process of evaluating response consistency and accuracy and selectively testing for a portion of training data based on embeddings of the portion of the training data, uptime of inference generation (e.g., using a trusted independent inference model) may be increased and/or maintained determining whether the updated inference model provides the consistent and accurate responses. Consequently, resources may be allocated to providing the computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, an inference model diagram in accordance with an embodiment is shown in FIG. 2I. The inference model diagram may illustrate a structure of the inference models and/or how data is processed/used within the system of FIG. 1 while performing an untraining process for an inference model (e.g., inference model 210).

Turning to FIG. 2I, a diagram illustrating a neural network (e.g., an implementation of an inference model) in accordance with an embodiment is shown. In FIG. 2I, neural network 270 may be similar to any inference model managed by local resource 102 and/or remote resource 106, discussed in FIG. 2A. For example, neural network 270 may be similar to inference model 210 described in FIGS. 2A-2H. Neural network 270 may include a series of layers of nodes (e.g., neurons, illustrated as circles). This series of layers may include input layer 272, hidden layer 274 (which may include different sub-layers of neurons), and output layer 276. Lines terminating in arrows in this diagram indicate data relationships (e.g., weights). For example, numerical values calculated with respect to each of the neurons during operation of neural network 270 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 270 may include any number of neurons and may include any number of sub-layers.

To decrease a likelihood that inferences generated by the inference model are based on undesirable training data (thereby indicating that the inference model has been sufficiently untrained on the undesirable training data), embodiments disclosed herein may provide a system and method for untraining inference models with respect to portions of training data previously used to train the inference models. To do so, the system may modify the parameters of neural network 270.

During an untraining procedure (e.g., untraining process 230 described in FIG. 2D), weights of neural network 270 may be modified to reduce an ability of neural network 270 to generate consistent and accurate responses to prompts intended to elicit an information content of the undesirable training data. To do so, weights of input layer 272, hidden layer 274, and/or output layer 276 may be placed in a mutable state and a process such as gradient ascent with respect to inference error may be performed. Completion of this untraining procedure may provide an updated set of weights for neural network 270. By doing so, the untraining procedure may cause neural network 270 to no longer provide responses that are based on the information content of the undesirable training data. The untraining procedure may include other methods without departing from embodiments disclosed herein.

Following the untraining procedure, a third testing process may be performed to determine whether the updated inference model is sufficiently untrained with respect to the undesirable training data. Performing the third testing process may include processes similar to those described with respect to the first testing process (e.g., FIGS. 2E-2H). However, a second set of prompts may be used, the second set of prompts being intended to elicit responses that have an information content of the undesirable training data. In addition, during the third training process, it may be determined (e.g., using a set of responses generated by the updated inference model in response to the second set of prompts) whether the set of responses are inconsistent (e.g., have a level of agreement that does not meet agreement criteria) and/or are inaccurate (e.g., have a level of similarity to the information content of the undesirable training data that does not meet a level of similarity threshold).

If the updated inference model generates inconsistent and/or inaccurate responses to the second set of prompts, the updated inference model may be considered sufficiently untrained with respect to the undesirable training data. If the updated inference model does not provide the inconsistent and/or inaccurate responses, additional untraining processes may be performed to reduce the updated inference model's ability to generate responses based on an information content of the undesirable training data.

While illustrated in FIG. 2I as including a limited number of specific components, a neural network may include fewer, additional, and/or different components than those illustrated in these figures without departing from embodiments disclosed herein.

As discussed above, the components of FIGS. 1-2I may perform various methods to manage inference models. FIGS. 3A-3C illustrate a method that may be performed by the components of the system of FIGS. 1-2I. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using inference models in accordance with an embodiment is shown. The method may be performed, for example, by any of the components of the system of FIG. 1, and/or any other entity without departing from embodiments disclosed herein.

At operation 300, a portion of training data that was used to train an inference model and is undesirable may be identified. Identifying the portion of the training data may include: (i) reading the portion of the training data from storage, the portion of the training data being labeled as undesirable, (ii) receiving the portion of the training data from another entity that identified the portion of the training data as undesirable, (iii) retrieving the portion of the training data (e.g., from a training data repository) by performing a filtering process, a lookup process, and/or any other process to search the training data repository for training data that meets undesirability criteria (e.g., has a known undesirable information content, was obtained from a known undesirable data source), and/or (iv) other methods.

At operation 302, a similarity analysis may be performed on the portion of the training data and other portions of the training data to identify whether any of the other portions of the training data are similar to the portion of the training data.

Performing the similarity analysis may include: (i) obtaining, using at least the portion of the training data, embeddings for the portion of the training data, (ii) obtaining, using the inference model and the other portions of the training data, embeddings for the other portions of the training data, (iii) performing, using the embeddings for the portion of the training data and the embeddings for the other portions of the training data, a comparison process to obtain similarity measures between the embeddings for the portion of the training data and the embeddings for the other portions of the training data, and/or (iv) determining whether any of the similarity measures exceed a similarity measure threshold. If at least one similarity measure of the similarity measures exceeds the similarity measure threshold, it may be concluded that the any of the other portions of the training data have similar embeddings to the portion of the training data. If none of the similarity measures exceed the similarity measure threshold, it may be concluded that the any of the other portions of the training data do not have similar embeddings to the portion of the training data.

Obtaining the embeddings for the potion of the training data may include: (i) reading the embeddings for the portion of the training data from storage, (ii) receiving the embeddings for the potion of the training data from another entity (e.g., in the form of a message over a communication system), (iii) generating the embeddings for the potion of the training data, and/or (iv) other methods.

Generating the embeddings for the potion of the training data may include feeding the portion of the training data into an input layer of the inference model and obtaining, as an output from another layer of the inference model (e.g., an embedding layer, a hidden layer) the embeddings for the potion of the training data. Generating the embeddings for the potion of the training data may also include feeding the portion of the training data into other models and/or using other methods without departing from embodiments disclosed herein.

Obtaining the embeddings for the other portions of the training data may include: (i) reading the embeddings for the other portions of the training data from storage, (ii) receiving the embeddings for the other portions of the training data from another entity (e.g., in the form of a message over a communication system), (iii) generating the embeddings for the other portions of the training data, and/or (iv) other methods.

Generating the embeddings for the other portions of the training data may include feeding the other portions of the training data into an input layer of the inference model and obtaining, as an output from another layer of the inference model (e.g., an embedding layer, a hidden layer) the embeddings for the other portions of the training data. Generating the embeddings for the other portions of the training data may also include feeding the other portions of the training data into other models and/or using other methods without departing from embodiments disclosed herein.

Performing the comparison process may include prompting the inference model (and/or any other model) to generate similarity measures for between the embeddings for the portion of the training data and the embeddings for the other portions of the training data.

Performing the comparison process may also include: (i) obtaining numerical representations of the embeddings for the portion of the training data and numerical representations of the embeddings for the other portions of the training data, (ii) generating the similarity measures (e.g., using any schema for assigning similarity measures between sets of numerical values), and/or (iii) other methods.

For example, a similarity measure may be generated between each embedding of the embeddings for the other portions of the training data and each embedding of the embeddings for the portion of the training data. The similarity measures may be represented as numerical values on a scale, percentages, and/or other representations of degrees of similarity.

Determining whether any of the similarity measures exceed the similarity measure threshold may include: (i) obtaining the similarity measure threshold (e.g., reading the similarity measure threshold from storage, receiving the similarity measure threshold from another entity, generating the similarity measure threshold based on feedback from a downstream consumer and/or another entity), (ii) comparing a quantity from each similarity measure (e.g., a number on a scale, a percentage) to a corresponding quantity of the similarity measure threshold, (iii) obtaining a list of similarity measures with quantities that exceed the corresponding quantity of the similarity measure threshold, and/or (iv) other methods.

Concluding that the any of the other portions of the training data have the similar embeddings may include: (i) populating a data structure using the list of the similarity measures that exceed the similarity measure threshold and identifiers for the other portions of the training data that correspond to the listed similarity measures, (ii) storing the data structure in storage, (iii) publishing the data structure for use by other entities, (iv) providing the data structure to an entity responsible for untraining and/or re-training the inference model, and/or (v) other methods.

Performing the similarity analysis may also include: (i) obtaining, using the portion of the training data, a first information content for the portion of the training data, (ii) obtaining, using the other portions of the training data, a second information content for the other portions of the training data, (iii) performing, using the first information content and the second information content, a comparison process to obtain a similarity score between the first information content and the second information content (e.g., indicating any of the other portions of the training data that may be similar to the portion of the training data (e.g., the undesirable training data)), and/or (iv) determining whether the similarity score (e.g., a portion of the similarity score, the overall similarity score) exceeds a similarity score threshold. If at least one portion of the similarity score exceeds the similarity measure threshold, it may be concluded that the any of the other portions of the training data are similar to the portion of the training data. If none of the portions of the similarity score exceed the similarity score threshold, it may be concluded that the any of the other portions of the training data are not similar to the portion of the training data.

At operation 304, it may be determined whether the any of the other portions of the training data are similar to the portion of the training data. Doing so may include: (i) reading a result of operation 302, (ii) obtaining the data structure generated in operation 302, and/or (iii) other methods.

If the any of the other portions of the training data are similar to the portion of the training data, the method may proceed to operation 306.

At operation 306, an untraining of the inference model may be performed using the portion of the training data to obtain an updated inference model. The untraining process may reduce the inference model's ability to generate responses based on an information content of the portion of the training data (e.g., information content that is to be removed from the knowledge base of the inference model). Performing the untraining may include: (i) placing weights of the inference model in a mutable state, (ii) untraining the inference model to reduce the inference model's ability to generate responses based on the portion of the training (e.g., via a gradient ascent process with respect to inference error and resulting in modification of the weights) to obtain the updated inference model, (iii) freezing the weights of the updated inference model (e.g., by placing the weights in an immutable state thereby preventing the weights), and/or (iv) other methods.

At operation 308, a compliance process may be performed for the updated inference model using the any of the other portions of the training data to obtain a compliant inference model. Performing the compliance process may include: (i) obtaining, based on the any of the other portions of the training data that are similar to the portion of the training data, a set of prompts intended to elicit responses that have a same information content as an information content of the any of the other portions of the training data that are similar, and/or (ii) performing, using the set of prompts, a first testing process to determine whether the updated inference model provides consistent and accurate responses to the set of prompts.

If the updated inference model provides the consistent and accurate responses, it may be concluded that the updated inference model is the compliant inference model.

If the updated inference model does not provide the consistent and accurate responses, performing the compliance process may also include: (i) performing a re-training process using the any of the other portions of the training data to obtain a re-trained updated inference model, and/or (ii) performing, using the set of prompts, a second testing process to determine whether the re-trained updated inference model provides the consistent and accurate responses.

If the re-trained updated inference model provides the consistent and accurate responses, it may be concluded that the re-trained updated inference model is the compliant inference model.

If the re-trained updated inference model does not provide the consistent and accurate responses, additional training and/or untraining may be performed for the re-trained updated inference model to increase a likelihood that a further updated inference model provides the consistent and accurate responses to the set of prompts.

Refer to FIGS. 3B-3C for additional details regarding performing the compliance process.

Following obtaining the compliant inference model, the compliant inference model may be used to provide the computer-implemented services. Providing the computer-implemented services using the compliant inference model may include replacing the inference model with the compliant inference model in the provision of the computer-implemented services. Replacing the inference model may include: (i) modifying instructions for inference generation, the instructions including a list of inference models usable for generation of inferences during providing the computer-implemented services (e.g., removing the inference model from the list, adding the compliant inference model to the list, labeling the inference model in the list as being replaced by the compliant inference model), (ii) providing the instructions and/or another notification to any entity (e.g., the remote resource, a downstream consumer) indicating that the inference model is to be replaced by the compliant inference model, and/or (iii) other methods.

Providing the computer-implemented services using the compliant inference model may also include: (i) notifying (e.g., via a message over a communication system, via a graphical user interface (GUI) on a device) another entity (e.g., the remote resource, the local resource, a downstream consumer) that the compliant inference model is approved for use in providing the computer-implemented services, (ii) obtaining a new prompt for the compliant inference model, (iii) providing the new prompt to the compliant inference model (e.g., feeding the new prompt to the compliant inference model as ingest), (iv) receiving, in response to the new prompt, a new response generated by the compliant inference model, (v) providing at least a portion of the new response to a downstream consumer as part of providing the computer-implemented services, (v) using at least a portion of the new response to make decisions related to provisioning of the computer-implemented services, and/or (vi) other methods.

The method may end following operation 308.

Returning to operation 304, the method may proceed to operation 310 if the any of the other portions of the training data are not similar to the portion of the training data.

At operation 310, the untraining of the inference model may be performed using the portion of the training data to obtain the compliant inference model. Performing the untraining of the inference model may include methods similar to those described with respect to operation 306.

The method may end following operation 310.

Thus, as illustrated above, embodiments disclosed herein may provide systems and methods usable to manage inference models so that an inference model may be untrained with respect to undesirable training data while retaining an ability to generate responses based on other training data. By identifying portions of the other training data that have similar embeddings to embeddings of the undesirable training data, the inference model may be selectively re-trained using the identified portions of the other training data thereby conserving resources that may otherwise be used to re-train the inference model on larger datasets. Consequently, the resources may be available for use in providing computer-implemented services.

Turning to FIG. 3B, a second flow diagram illustrating a method for performing a compliance process in accordance with an embodiment is shown. The method may be performed, for example, by any of the components of the system of FIG. 1, and/or any other entity without departing from embodiments disclosed herein. The operations shown in FIG. 3B may be a partial expansion of operation 308 in FIG. 3A.

At operation 320, a set of prompts may be obtained based on the any of the other portions of the training data that are similar to the portion of the training data. The set of prompts may be intended to elicit responses that have a same information content as an information content of the any of the other portions of the training data that are similar. Obtaining the set of prompts may include: (i) reading the set of prompts from storage, (ii) receiving the prompts from another entity (e.g., via a message over a communication system), (iii) generating the set of prompts, and/or (iv) other methods.

Generating the set of prompts may include prompting a generative AI model (e.g., the inference model) to generate the set of prompts based on the information content of the any of the other portions of the training data.

At operation 322, a first testing process may be performed, using the set of prompts, to determine whether the updated inference model provides consistent and accurate responses to the set of prompts.

Performing the first testing process may include: (i) obtaining, using the set of prompts, a first set of responses from the updated inference model, the first set of responses including a first response of the first set of responses to a first prompt of the set of prompts and a second response of the first set of responses to a second prompt of the set of prompts, (ii) performing a first response agreement testing process to obtain a first level of agreement between at least the first response of the first set of responses and the second response of the first set of responses, and/or (iii) determining whether the first level of agreement meets agreement criteria.

If the first level of agreement does not meet the agreement criteria, performing the first testing process may also include: concluding that the updated inference model does not provide the consistent and accurate responses to the set of prompts.

If the first level of agreement meets the agreement criteria, performing the first testing process may also include: (i) concluding that the updated inference model provides consistent responses to the set of prompts, (ii) comparing a first information content of the consistent responses to a second information content of the any of the other portions of the training data to obtain a first level of similarity between the first information content and the second information content, and/or (iii) determining whether the first level of similarity meets a level of similarity threshold.

If the first level of similarity meets the level of similarity threshold, performing the first testing process may also include concluding that the updated inference model provides the consistent and accurate responses to the set of prompts.

If the first level of ability does not meet the level of similarity threshold, performing the first testing process may also include concluding that the updated inference model does not provide the consistent and accurate responses to the set of prompts.

Obtaining the first set of responses from the updated inference model may include: (i) feeding the set of prompts to the updated inference model as ingest, (iii) receiving, in response to the set of prompts, the first set of responses, and/or (iv) other methods.

Performing the first response agreement testing process may include: (i) prompting the inference model and/or a second inference model (e.g., a trusted inference model that is deemed consistent and correct) to compare an information content of at least the first response and the second response, (ii) obtaining an output from the inference model, the output being usable to obtain the level of agreement, and/or (iii) other methods.

Performing the first response agreement testing process may also include obtaining the first level of agreement. Obtaining the first level of agreement may include: (i) parsing the output from the inference model to identify the first level of agreement from the output, (ii) performing an analysis process and/or a data processing process using the output from the inference model to obtain the first level of agreement, and/or (iii) other methods.

Determining whether the first level of agreement meets the agreement criteria may include: (i) obtaining the agreement criteria (e.g., reading the agreement criteria from storage, receiving the agreement criteria from another entity, generating the agreement criteria), (ii) comparing a quantity of the first level of agreement to a corresponding threshold quantity of the agreement criteria, and/or (iii) other methods. Determining whether the first level of agreement meets the agreement criteria may also include providing the first level of agreement and the agreement criteria to another entity responsible for comparing the first level of agreement to the agreement criteria.

Concluding that the updated inference model does not provide the consistent and accurate responses to the set of prompts may include: (i) generating a data structure indicating that the updated prototype inference model does not provide the consistent and accurate responses to the set of prompts, (ii) storing the data structure in a database and/or other storage architecture, (iii) notifying (e.g., via a message over a communication system, via a graphical user interface (GUI) on a device) another entity (e.g., the remote resource, the local resource, a downstream consumer) that the updated inference model does not provide the consistent and accurate responses to the set of prompts, and/or (iv) other methods.

Concluding that the updated inference model provides the consistent and accurate responses to the set of prompts may include: (i) generating a data structure indicating that the updated prototype inference model provides the consistent and accurate responses to the set of prompts, (ii) storing the data structure in a database and/or other storage architecture, (iii) notifying (e.g., via a message over a communication system, via a graphical user interface (GUI) on a device) another entity (e.g., the remote resource, the local resource, a downstream consumer) that the updated inference model provides the consistent and accurate responses to the set of prompts, and/or (iv) other methods.

Comparing the first information content of the consistent responses to the second information content of the any of the other portions of the training data may include: (i) prompting the inference model and/or the second inference model to compare the first information content and the second information content (e.g., providing the inference model a prompt, the prompt including instructions for the inference model to compare the first information content and the second information content), (ii) obtaining an output from the inference model, the output being usable to obtain the first level of similarity, and/or (iii) other methods.

Making a determination regarding whether the first level of similarity meets the level of similarity threshold may include: (i) obtaining the level of similarity threshold (e.g., reading the level of similarity threshold from storage, receiving the level of similarity threshold from another entity, generating the level of similarity threshold), (ii) comparing a quantity of the first level of similarity to a corresponding threshold quantity of the level of similarity threshold, and/or (iii) other methods. Determining whether the first level of similarity meets the level of similarity threshold may also include providing the first level of similarity and the level of similarity threshold to another entity responsible for comparing the first level of similarity to the level of similarity threshold.

If the first level of similarity meets the level of similarity threshold, it may be concluded that the updated inference model provides the consistent and accurate responses. Concluding that the updated inference model provides the consistent and accurate responses may include: (i) generating a data structure indicating that the updated inference model provides the consistent and accurate responses, (ii) storing the data structure in a database and/or other storage architecture for retrieval when determining whether the updated inference model is a compliant inference model (refer to FIG. 3A), (iii) notifying (e.g., via a message over a communication system, via a graphical user interface (GUI) on a device) another entity (e.g., the remote resource, the local resource, a downstream consumer) that the updated inference model provides the consistent and accurate responses, and/or (iv) other methods.

If the level of similarity does not meet the level of similarity threshold, it may be concluded that the updated inference model does not provide the consistent and accurate responses. Concluding that the updated inference model does not provide the consistent and accurate responses may include: (i) generating a data structure indicating that the updated inference model does not provide the consistent and accurate responses, (ii) storing the data structure in a database and/or other storage architecture for retrieval when determining whether the updated inference model is the compliant inference model (refer to FIG. 3A), (iii) notifying (e.g., via a message over a communication system, via a graphical user interface (GUI) on a device) another entity (e.g., the remote resource, the local resource, a downstream consumer) that the updated inference model does not provide the consistent and accurate responses, and/or (iv) other methods.

At operation 324, it may be determined whether the inference model provides consistent and accurate responses. Determining whether the inference model provides the consistent and accurate responses may include: (i) reading a result of operation 322, (ii) obtaining the data structure indicating whether the inference model provides the consistent and accurate responses, (iii) receiving a notification from another entity indicating whether the inference model provides the consistent and accurate responses, and/or (iv) other methods.

If the inference model provides the consistent and accurate responses, the method may proceed to operation 326.

At operation 326, it may be concluded that the updated inference model is the compliant inference model. Concluding that the updated inference model is the compliant inference model may include: (i) concluding the updated inference model is sufficiently untrained (e.g., identifying that the untraining procedure is complete, not continuing to perform additional partial untraining procedures for the updated inference model), (ii) generating a data structure indicating that the updated inference model has been promoted to the compliant inference model, (iii) storing the data structure in a database and/or other storage architecture for retrieval during providing the computer-implemented services, (iv) notifying (e.g., via a message over a communication system, via a graphical user interface (GUI) on a device) another entity (e.g., the remote resource, the local resource, a downstream consumer) that the updated inference model has been promoted to the compliant inference model and, therefore, approved for use in providing the computer-implemented services, and/or (v) other methods.

The method may end following operation 326.

Returning to operation 324, the method may proceed to operation 328 if the updated inference model does not provide the consistent and accurate responses.

At operation 328, a re-training process may be performed using any of the other portions of the training data to obtain a re-trained updated inference model. Performing the re-training process may include performing any training process (e.g., a global optimization process using gradient descent) using the other portions of the training data, the other portions of the training data indicating goals for outputs generated by the re-trained updated inference model (e.g., responses). Parameters of the re-trained updated inference model may be selected using an optimization process (e.g., an objective function may be defined in terms of the other portions of the training data and responses generated by the re-trained updated inference model, and a global optimization method such as gradient descent may be used to identify parameters that most faithfully reproduce the trends in the other portions of the training data).

Performing the re-training process may include other methods without departing from embodiments disclosed herein.

Following operation 328, the method may continue in FIG. 3C.

Turning to FIG. 3C, a third flow diagram illustrating a method for performing a compliance process in accordance with an embodiment is shown. The method may be performed, for example, by any of the components of the system of FIG. 1, and/or any other entity without departing from embodiments disclosed herein. The operations shown in FIG. 3C may be a partial expansion of operation 308 in FIG. 3A.

At operation 330, a second testing process may be performed using the set of prompts to determine whether the re-trained updated inference model provides consistent and accurate responses to the set of prompts. Performing the second testing process may include methods similar to those described in operation 322 with respect to the first testing process.

At operation 332, it may be determined whether the re-trained updated inference model provides the consistent and accurate responses. Determining whether the re-trained updated inference model provides the consistent and accurate responses may include methods similar to those described in operation 324 of FIG. 3B.

If the re-trained updated inference model provides the consistent and accurate responses, the method may proceed to operation 334.

At operation 334, it may be concluded that the re-trained updated inference model is a compliant inference model. Concluding that the re-trained updated inference model is the compliant inference model may include methods similar to those described with respect to operation 326 in FIG. 3B.

The method may end following operation 334.

Returning to operation 332, the method may proceed to operation 336 if the re-trained updated inference model does not provide the consistent and accurate responses.

At operation 336, additional training and/or re-training processes may be performed for the re-trained updated inference model to increase a likelihood that a further updated inference model provides the consistent and accurate responses to the set of prompts. Performing the additional training and/or re-training processes may include: (i) performing a second re-training process for the re-trained updated inference model using the other portions of the training data to obtain the further updated inference model (e.g., via methods similar to those described with respect to operation 328 in FIG. 3B), (ii) performing a third testing process for the further updated inference model to determine whether the further updated inference model provides the consistent and accurate responses (e.g., via methods similar to those described with respect to operation 322 in FIG. 3B), and/or (iii) other methods.

The method may end following operation 336.

Thus, as illustrated above, embodiments disclosed herein may provide systems and methods usable to manage inference models so that a knowledge base of an inference model may be evaluated. The knowledge base of the inference model may be evaluated by evaluating an ability of the inference model to provide consistent and accurate responses to a set of prompts based on other portions of training data with embeddings similar to undesirable portions of the training data. By re-training the inference model using the other portions of the training data and evaluating the inference model during untraining and re-training, an efficiency of untraining and re-training the inference model may be increased (e.g., via reduction of a resource cost) and a likelihood of providing the computer-implemented services as desired may be increased.

Any of the components illustrated in FIGS. 1-2H may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using inference models, the method comprising:
identifying a portion of training data that:
was used to train an inference model of the inference models, and
is undesirable;
performing a similarity analysis on the portion of the training data and other portions of the training data to identify whether any of the other portions of the training data are similar to the portion of the training data;
in a first instance of the performing where the any of the other portions of the training data are similar to the portion of the training data:
performing an untraining of the inference model using the portion of the training data to obtain an updated inference model, and
performing a compliance process for the updated inference model using the any of the other portions of the training data to obtain a compliant inference model that reflects relationships defined by the any of the other portions of the training data; and
in a second instance of the performing where the any of the other portions of the training data do not have similar embeddings to the portion of the training data:
performing the untraining of the inference model using the portion of the training data to obtain the compliant inference model.

2. The method of claim 1, further comprising:
providing computer-implemented services using the compliant inference model.

3. The method of claim 1, wherein the portion of the training data is undesirable due to the portion of the training data comprising at least one type of training data selected from a list of types of training data consisting of:
poisoned training data comprising malicious relationships established by a malicious entity; and
proprietary training data comprising confidential relationships ascribed to an owner of the proprietary training data.

4. The method of claim 1, wherein performing the similarity analysis comprises:
obtaining, using at least the portion of the training data, embeddings for the portion of the training data;
obtaining, using the inference model and the other portions of the training data, embeddings for the other portions of the training data;
performing, using the embeddings for the portion of the training data and the embeddings for the other portions of the training data, a comparison process to obtain similarity measures between the embeddings for the portion of the training data and the embeddings for the other portions of the training data;
making a first determination regarding whether any of the similarity measures exceed a similarity measure threshold; and
in an instance of the first determination in which at least one similarity measure of the similarity measures exceeds the similarity measure threshold:
concluding that the any of the other portions of the training data are similar to the portion of the training data.

5. The method of claim 4, wherein performing the compliance process comprises:
obtaining, based on the any of the other portions of the training data that are similar to the portion of the training data, a set of prompts intended to elicit responses that have a same information content as an information content of the any of the other portions of the training data that have the similar embeddings;
performing, using the set of prompts, a first testing process to determine whether the updated inference model provides consistent and accurate responses to the set of prompts; and
in a first instance of the performing the first testing process in which the updated inference model does not provide the consistent and accurate responses:
performing, using the any of the other portions of the training data, a re-training process for the updated inference model to obtain a re-trained updated inference model;
performing, using the set of prompts, a second testing process to determine whether the re-trained updated inference model provides the consistent and accurate responses; and
in a first instance of the performing the second testing process in which the re-trained updated inference model provides the consistent and accurate responses:
concluding that the re-trained updated inference model is the compliant inference model.

6. The method of claim 5, further comprising:
in a second instance of the performing the first testing process in which the updated inference model provides the consistent and accurate responses:
concluding that the updated inference model is the compliant inference model.

7. The method of claim 5, further comprising:
in a second instance of the performing the second testing process in which the re-trained updated inference model does not provide the consistent and accurate responses:
performing additional training and/or untraining for the re-trained updated inference model to increase a likelihood that a further updated inference model provides the consistent and accurate responses to the set of prompts.

8. The method of claim 5, wherein performing the first testing process comprises:
obtaining, using the set of prompts, a first set of responses from the updated inference model, the first set of responses comprising:
a first response of the first set of responses to a first prompt of the set of prompts; and
a second response of the first set of responses to a second prompt of the set of prompts;
performing a first response agreement testing process to obtain a first level of agreement between at least the first response of the first set of responses and the second response of the first set of responses;
making a second determination regarding whether the first level of agreement meets agreement criteria;
in a first instance of the second determination in which the first level of agreement meets the agreement criteria:
concluding that the updated inference model provides consistent responses to the set of prompts; and
in a second instance of the second determination in which the first level of agreement does not meet the agreement criteria:
concluding that the updated inference model does not provide the consistent and accurate responses to the set of prompts.

9. The method of claim 8, wherein performing the first testing process further comprises:
in the first instance of the second determination in which the first level of agreement meets the agreement criteria:
comparing a first information content of the consistent responses to a second information content of the any of the other portions of the training data to obtain a first level of similarity between the first information content and the second information content;
making a third determination regarding whether the first level of similarity meets a level of similarity threshold;
in a first instance of the third determination in which the first level of similarity meets the level of similarity threshold:
concluding that the updated inference model provides the consistent and accurate responses to the set of prompts; and
in a second instance of the third determination in which the first level of similarity does not meet the level of similarity threshold:
concluding that the updated inference model does not provide the consistent and accurate responses to the set of prompts.

10. The method of claim 5, wherein performing the second testing process comprises:
obtaining, using the set of prompts, a second set of responses from the re-trained updated inference model, the second set of responses comprising:
a first response of the second set of responses to a first prompt of the set of prompts; and
a second response of the second set of responses to a second prompt of the set of prompts;
performing a second response agreement testing process to obtain a second level of agreement between at least the first response of the second set of responses and the second response of the second set of responses;
making a fourth determination regarding whether the second level of agreement meets agreement criteria;
in a first instance of the fourth determination in which the second level of agreement meets the agreement criteria:
concluding that the re-trained updated inference model provides consistent responses to the set of prompts; and
in a second instance of the fourth determination in which the second level of agreement does not meet the agreement criteria:
concluding that the re-trained updated inference model does not provide the consistent and accurate responses to the set of prompts.

11. The method of claim 10, wherein performing the second testing process further comprises:
in the first instance of the fourth determination in which the second level of agreement meets the agreement criteria:
comparing a third information content of the consistent responses provided by the re-trained updated inference model to a second information content of the any of the other portions of the training data to obtain a second level of similarity between the third information content and the second information content;
making a fifth determination regarding whether the second level of similarity meets the level of similarity threshold;
in a first instance of the fifth determination in which the second level of similarity meets the level of similarity threshold:
concluding that the re-trained updated inference model provides the consistent and accurate responses to the set of prompts; and
in a second instance of the fifth determination in which the second level of similarity does not meet the level of similarity threshold:
concluding that the re-trained updated inference model does not provide the consistent and accurate responses to the set of prompts.

12. The method of claim 5, wherein providing the consistent and accurate responses to the set of prompts indicates that a knowledge base of the re-trained updated inference model has an information content of the any of the other portions of the training data.

13. The method of claim 1, wherein performing the untraining of the inference model comprises:
modifying weights of an architecture of the inference model until responses generated by the inference model are not based on an information content of the portion of the training data.

14. The method of claim 1, wherein the inference model is a generative artificial intelligence (AI) model.

15. The method of claim 1, wherein the similarity analysis is an embeddings based similarity analysis or an information content based similarity analysis.

16. A non-transitory machine-readable medium having instructions stored therein, which when executed by a processor, cause the processor to perform operations for providing computer-implemented services using inference models, the operations comprising:
identifying a portion of training data that:
was used to train an inference model of the inference models, and is undesirable;
performing a similarity analysis on the portion of the training data and other portions of the training data to identify whether any of the other portions of the training data are similar to the portion of the training data;
in a first instance of the performing where the any of the other portions of the training data are similar to the portion of the training data:
performing an untraining of the inference model using the portion of the training data to obtain an updated inference model, and
performing a compliance process for the updated inference model using the any of the other portions of the training data to obtain a compliant inference model that reflects relationships defined by the any of the other portions of the training data; and
in a second instance of the performing where the any of the other portions of the training data do not have similar embeddings to the portion of the training data:
performing the untraining of the inference model using the portion of the training data to obtain the compliant inference model.

17. The non-transitory machine-readable medium of claim 16, wherein the operations further comprise:
providing computer-implemented services using the compliant inference model.

18. The non-transitory machine-readable medium of claim 16, wherein the portion of the training data is undesirable due to the portion of the training data comprising at least one type of training data selected from a list of types of training data consisting of:
poisoned training data comprising malicious relationships established by a malicious entity; and
proprietary training data comprising confidential relationships ascribed to an owner of the proprietary training data.

19. A data processing system, comprising:
a processor; and
a memory coupled to the processor to store instructions, which when executed by the processor, cause the processor to perform operations for providing computer-implemented services using inference models, the operations comprising:
identifying a portion of training data that:
was used to train an inference model of the inference models, and
is undesirable;
performing a similarity analysis on the portion of the training data and other portions of the training data to identify whether any of the other portions of the training data are similar to the portion of the training data;
in a first instance of the performing where the any of the other portions of the training data are similar to the portion of the training data:
performing an untraining of the inference model using the portion of the training data to obtain an updated inference model, and
performing a compliance process for the updated inference model using the any of the other portions of the training data to obtain a compliant inference model that reflects relationships defined by the any of the other portions of the training data; and
in a second instance of the performing where the any of the other portions of the training data do not have similar embeddings to the portion of the training data:
performing the untraining of the inference model using the portion of the training data to obtain the compliant inference model.

20. The data processing system of claim 19, wherein the operations further comprise:
providing computer-implemented services using the compliant inference model.
